(19) United States
(12) Patent Application Publication
(10) Pub. No.: US 2025/0258133 A1
(43) Pub. Date: Aug. 14, 2025

(54) COMPUTER-IMPLEMENTED METHOD FOR DETECTING AT LEAST ONE ANALYTE IN A SAMPLE WITH A LASER DESORPTION MASS SPECTROMETER

(71) Applicant: Roche Diagnostics Operations, Inc., Indianapolis, IN (US)

(72) Inventors: Martin Rempt, Penzberg (DE); Manuel Josef Seitz, Berg (DE); Christoph Zuth, Eglfing (DE)

(21) Appl. No.: 19/177,070

(22) Filed: Apr. 11, 2025

Related U.S. Application Data
(63) Continuation of application No. PCT/EP2023/078341, filed on Oct. 12, 2023.

(30) Foreign Application Priority Data
Oct. 13, 2022 (EP) 22201318.7

(51) Int. Cl. G01N 27/623; H01J 49/00

(52) U.S. Cl. CPC G01N 27/623; H01J 49/0004; H01J 49/0036

(57) ABSTRACT

A computer-implemented method for detecting at least one analyte in a sample with a laser desorption mass spectrometer (220) is disclosed. The method comprises:
a) at least one imaging step comprising imaging at least one reflective target (128) by using at least one imaging device (235), wherein the sample comprising the at least one analyte is applied to the reflective target (128);
b) at least one sample recognition step comprising localizing at least one sample region on the reflective target (128); and
c) at least one analyte detection step comprising detecting the at least one analyte in the sample using surface assisted laser desorption ionization mass spectrometry (SALDI-MS) with the laser desorption mass spectrometer (220), wherein laser irradiation is applied to the reflective target (128) by using at least one laser source (222) of the laser desorption mass spectrometer (220) such that at least one ion of the at least one analyte is generated which is detected by using at least one of a mass analyzing unit (224) or an ion-mobility spectrometry device of the laser desorption mass spectrometer (220), wherein the laser irradiation is steered on the localized sample region by using at least one control device (237).

### TECHNICAL FIELD

The invention relates to a computer-implemented method for detecting at least one analyte in a sample with a laser desorption mass spectrometer, a system comprising at least one laser desorption mass spectrometer and a computer program. The method and devices may be applied for measuring a mass of an analyte or a mass of fragments of the analyte for the purpose of identifying the analyte, as well as the quantitative determination of the analyte. Specifically, the devices and method may be applied for the quantitative analysis of biological molecules such as proteins, peptides, oligonucleotides and small molecular compounds. Other applications, however, are also feasible.

### BACKGROUND ART

Matrix-assisted laser desorption/ionization (MALDI) mass spectrometry is an ionization technique that applies the combination of irradiation absorbing small organic matrix molecules together with a respective analyte of interest. As the ionization process itself tends to be soft, it is nowadays a well-established analysis method especially of biomolecules, like proteins or peptides.

A variation of this technology is the surface assisted laser desorption ionization (SALDI) process. In contrast to MALDI-MS, no further organic matrix substances are mixed in excess with an analyte of interest. Instead, a functional solid surface is utilized for desorbing and ionizing the analytes. Based on the elemental composition, the majority of the functional SALDI materials reported in the literature can commonly be classified into three main types: carbon-based, semiconductor-based and metallic-based. In G. Eppe et al., Surface-assisted laser desorption/ionization mass spectrometry imaging: A review, Mass Spec Rev. 2022; 41:373-420 (DOI: 10.1002/mas.21670) a review on surface assisted laser desorption ionization for mass spectrometry analysis is provided.

In principle, a goal of SALDI is to enter a mass-to-charge ratio m/z of small molecules, specifically of small molecules having a molar mass being smaller than 1000 Da. Such molecules are usually hidden or suppressed with conventional MALDI approaches by having interference signals from the matrix. Furthermore, to avoid certain matrix application processing steps SALDI is commonly advantageous. Usually, co-crystallization processes with the analyte can lead to problems if quantification precision is needed.

Classical MALDI approaches aiming a controlled detection and laser irradiation of flawless matrix-analyte-crystals to generate optimal MALDI-MS spectra have already been demonstrated. With regard to descriptive works in the field of MALDI-MS it can be referred to the following literature:

JP5504282B2 describes a MALDI mass analysis method with which a high-quality MS spectrum can be efficiently obtained in a short period of time, by precisely predicting a sweet spot at which a high amount of ions are generated. A sweet-spot prediction method is described in which mixed crystals of a matrix and a sample containing molecules to be measured are separated, local analysis of the mixed crystals is then performed using an analysis method other than mass spectrometry, after which MALDI mass analysis is performed to specify in advance the analysis result of a portion of the mixed crystals that will become and/or will not become a sweet spot. Next, mixed crystals of said matrix and a sample containing molecules to be measured are separated, local analysis of said mixed crystals is then performed using said analysis method other than mass spectrometry, a portion of the mixed crystals which presents said analysis result of becoming and/or not becoming a sweet spot is detected, and prediction is performed as to whether that portion is and/or is not a sweet spot. A MALDI mass analysis method is also described which uses the sweet-spot prediction method.

U.S. Pat. No. 7,359,574B2 describes a mass spectrometry apparatus which uses image processing of output signals of a camera in a mass spectrometer to provide feedback for directing the laser. A determination of where samples have actually been deposited on a plate and a selection of different points for each sample, based on its structure, at which to aim a laser, during the cycle period of the mass spectrometer are described. Such feedback information increases the likelihood that the laser impinges samples and provides useful data.

WO2006116166A2 describes a method and apparatus for performing image analysis of a sample target area on a MALDI sample plate to select laser impingement locations for optimal mass spectra acquisition. The target area image is captured and analyzed to determine the incidence distribution of picture element values (representative of luminance and/or chrominance information). A dynamic threshold value may be determined by constructing a virtual histogram and then identifying a value at which a local minimum occurs between modes of a bimodal distribution. The threshold value is applied to the picture elements to locate regions within the target area that possess desired visual characteristics, such as a high luminance indicative of a crystalline structure. Mass spectra acquisition may be optimized by directing the laser beam to impinge at only those regions that possess the desired visual characteristic. The mass spectrometer performance may be further improved by coupling the image analysis process to an auto-spectrum filtering technique, whereby the laser beam is selectively held at or moved from a region of the sample spot based on whether the resultant mass spectrum meets predetermined performance criteria.

U.S. Pat. No. 6,956,208B2 describes a MALDI mass spectrometer which directs a laser shot onto a MALDI sample to generate a sample spectrum which is analyzed to determine if the sample spectrum meets a predetermined criteria. If so, subsequent laser shots are directed to predetermined locations on the MALDI sample. In essence, if the analysis of a previous laser shot indicates that a “sweet spot” of the MALDI sample has be located, subsequent laser shots may be directed to areas proximate to the previous shot thereby allowing the sweet spot to be thoroughly sampled. A method of operating a MALDI mass spectrometer is also described.

Despite the advantages achieved by the above-mentioned devices, several technical challenges remain.

Quantitative approaches with SALDI are commonly of high interest due to its potential for ultra-fast analysis times to acquire spectra over a dried spot of analyte on a certain SALDI target. Up to now, no algorithm is known which steers the laser irritation only on the dried spot for the respective SALDI target. Usually, after recognition of the spot, a dedicated laser irritation is possible while leaving out to irritate a blank spot area. Without an automated recognition, a considerable longer acquisition time by running pre-programmed laser paths is commonly present.

### Problem to be Solved

It is therefore desirable to provide a computer-implemented method for detecting at least one analyte in a sample with a laser desorption mass spectrometer, a system comprising at least one laser desorption mass spectrometer and a computer program which at least partially address the above-mentioned technical challenges. Specifically, a rapid measurement of an analyte spot shall be provided.

### SUMMARY

This problem is addressed by a computer-implemented method for detecting at least one analyte in a sample with a laser desorption mass spectrometer, a system comprising at least one laser desorption mass spectrometer and a computer program with the features of the independent claims. Advantageous embodiments which might be realized in an isolated fashion or in any arbitrary combinations are listed in the dependent claims as well as throughout the specification.

As used in the following, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically will be used only once when introducing the respective feature or element. In the following, in most cases, when referring to the respective feature or element, the expressions “at least one” or “one or more” will not be repeated, non-withstanding the fact that the respective feature or element may be present once or more than once.

Further, as used in the following, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person will recognize, be performed by using alternative features. Similarly, features introduced by “in an embodiment of the invention” or similar expressions are intended to be optional features, without any restriction regarding alternative embodiments of the invention, without any restriction regarding the scope of the invention and without any restriction regarding the possibility of combining the features introduced in such way with other optional or non-optional features of the invention.

In a first aspect of the present invention, a computer-implemented method for detecting at least one analyte in a sample with a laser desorption mass spectrometer is disclosed.

The method comprises the following steps which specifically may be performed in the given order. It shall be noted, however, that a different order is also possible. Further, it is also possible to perform one or more of the method steps once or repeatedly. Further, it is possible to perform two or more of the method steps simultaneously or in a timely overlapping fashion. The method may comprise further method steps which are not listed.

The method comprises the following steps:
a) at least one imaging step comprising imaging at least one reflective target by using at least one imaging device, wherein the sample comprising the at least one analyte is applied to the reflective target;
b) at least one sample recognition step comprising localizing at least one sample region on the reflective target; and
c) at least one analyte detection step comprising detecting the at least one analyte in the sample using surface assisted laser desorption ionization mass spectrometry (SALDI-MS) with the laser desorption mass spectrometer, wherein laser irradiation is applied to the reflective target by using at least one laser source of the laser desorption mass spectrometer such that at least one ion of the at least one analyte is generated which is detected by using at least one of a mass analyzing unit or an ion-mobility spectrometry device of the laser desorption mass spectrometer, wherein the laser irradiation is steered on the localized sample region by using at least one control device.

The term “computer implemented” as used herein is a broad term and is to be given its ordinary and customary meaning to a person of ordinary skill in the art and is not to be limited to a special or customized meaning. The term specifically may refer, without limitation, to a method involving at least one computer and/or at least one computer network. The computer and/or computer network may comprise at least one processor which is configured for performing at least one of the method steps of the method according to the present invention. Preferably each of the method steps is performed by the computer and/or computer network. The method may be performed completely automatically, such as without user interaction. The term “automatically” as used herein is a broad term and is to be given its ordinary and customary meaning to a person of ordinary skill in the art and is not to be limited to a special or customized meaning. The term specifically may refer, without limitation, to a process which is performed completely by means of at least one computer and/or computer network and/or machine, in particular without manual action and/or interaction with a user.

The computer-implemented method for detecting at least one analyte in a sample with a laser desorption mass spectrometer may be conducted at least partially automatically. Specifically, at least one of steps a) and c) may be conducted automatically.

The computer-implemented method for detecting at least one analyte in a sample with a laser desorption mass spectrometer may be conducted fully automatically, specifically from a sample preparation to the analyte detection step. Specifically, at least steps a), b) and c) may be conducted automatically. As will be outlined in further detail below, the computer-implemented method for detecting at least one analyte may further comprise at least one sample preparation step. The sample preparation step may also be conducted at least partially or fully automatically.

The method may be performed completely automatically. Steps a) to c), e.g. and further optional method steps, may be performed completely automatically. Steps a) and b), e.g. image processing and image recognition, may be performed fully automated. A system, e.g. the system proposed in a further aspect herein, may perform the method fully automated. The system may be configured for performing the method fully automated, starting from sample preparation to the detecting of analyte using the SALDI-MS. Performing the method automatically may allow increasing sample throughput.

The term “sample” as used herein is a broad term and is to be given its ordinary and customary meaning to a person of ordinary skill in the art and is not to be limited to a special or customized meaning. The term specifically may refer, without limitation, to an arbitrary sample such as a biological sample, also called test sample, a quality control sample, an internal standard sample. The sample may comprise one or more analytes of interest. The sample may specifically be a liquid sample, in particular a liquid sample comprising at least one biological material. Further, the analyte may be provided in a sample, specifically in a tissue sample or in a processed serum sample. The tissue sample may specifically have a slice thickness of less than 500 μm. For example, the sample may be selected from the group consisting of: a physiological fluid, including blood, serum, plasma, saliva, ocular lens fluid, cerebral spinal fluid, sweat, urine, milk, ascites fluid, mucous, synovial fluid, peritoneal fluid, amniotic fluid, tissue, cells or the like. The sample may be used directly as obtained from the respective source or may be subject of a pretreatment and/or sample preparation workflow. For example, the sample may be pretreated by adding an internal standard and/or by being diluted with another solution and/or by being mixed with reagents or the like. The quality control sample may be a sample that mimics the test sample, and that comprises known values of one or more quality control substances. The quality control substance may be identical to the analyte of interest or may be an analyte which generates by reaction or derivatization an analyte identical to the analyte of interest and/or may be an analyte of which the concentration is known and/or may be a substance which mimics the analyte of interest or that can be otherwise correlated to a certain analyte of interest. The internal standard sample may be a sample comprising at least one internal standard substance with a known concentration.

The term “analyte” as used herein is a broad term and is to be given its ordinary and customary meaning to a person of ordinary skill in the art and is not to be limited to a special or customized meaning. The term specifically may refer, without limitation, to an arbitrary chemical or biological substance or species, such as a molecule or a chemical compound, to be detected and/or measured. Specifically, a presence, an absence, a concentration and/or an amount of the analyte in a sample may be detected or measured. Specifically, the analyte may be a biological molecule or macromolecule. The analyte may be selected from the group consisting of: a steroid; specifically a ketosteroid, specifically a secosteroid such as vitamin D; a therapeutically active substance; a detergent; a glycoside; a peptide; a protein; a dye; an ion; a nucleic acid; an amino acid; a metabolite; a hormone; a fatty acid; a lipid; a carbohydrate. Further, the analyte may be a molecule characteristic of a certain modification of another molecule or a substance that has been internalized by an organism or a metabolite of such a substance or a combination thereof. However, also different kinds of analytes may be feasible. The steroid may be selected from the group consisting of: progesterone, testosterone, estradiol, androstenedione, cortisol, cortisone, 21-deoxycortisol. However, also other steroids may be feasible. The therapeutically active substance may be selected from the group consisting of: digitoxin, mycophenolic acid, theophylline, lidocaine, digoxin, voriconazole, 4-hydoxyalprazolam, cyclosporine A. However, also other therapeutically active substances may be feasible. The analyte may comprise permanently positive charged molecules or permanently negative charged molecules. Further, the analyte may have an isotope pattern. The analyte may have a molar mass from 6 Da to 10000 Da, preferably from 50 Da to 3000 Da, most preferably from 100 Da to 2000 Da. However, in principle, all kinds of analytes which may be applicable onto the reflective target may be feasible.

The term “mass spectrometer” as used herein is a broad term and is to be given its ordinary and customary meaning to a person of ordinary skill in the art and is not to be limited to a special or customized meaning. The term specifically may refer, without limitation, to an arbitrary analytical device which is configured for determining or measuring a mass-to-charge ratio of ions. Measurement results may specifically be presented as a mass spectrum, e.g. a plot of intensity as a function of the mass-to-charge ratio.

The term “laser desorption mass spectrometer” as used herein is a broad term and is to be given its ordinary and customary meaning to a person of ordinary skill in the art and is not to be limited to a special or customized meaning. The term specifically may refer, without limitation, to an arbitrary mass spectrometer based on an ionization technique using a laser. Specifically, the term may refer to a mass spectrometer which uses a medium and a laser for desorbing and ionizing a sample or parts of a sample from the medium. Specifically, the medium may absorb energy from a laser and may then transfer the energy to the sample or parts thereof. The ionization technique may also be referred to as soft ionization technique. The laser desorption mass spectrometer may specifically be configured as a surface-assisted laser desorption/ionization (SALDI) technique. The SALDI technique may comprise at least three different stages. At a first stage, a sample may be applied on a target. At a second stage, laser pulses of a laser may be applied to the target and the target may absorb laser energy and transfer the laser energy to molecules of the sample. At a third stage, desorption and ionization may occur and a potential difference may accelerate produced ions into a mass analyzer. A laser desorption mass spectrometric may include a process of analyzing a sample by using the laser desorption mass spectrometer. The detection may specifically refer to an identifying of an analyte of a sample. The detection may be a qualitative and/or a quantitative detection.

As outlined above, step a) corresponds to at least one imaging step comprising imaging the at least one reflective target by using the at least one imaging device, wherein the sample comprising the at least one analyte is applied to the reflective target.

The term “imaging step” as used herein is a broad term and is to be given its ordinary and customary meaning to a person of ordinary skill in the art and is not to be limited to a special or customized meaning. The term specifically may refer, without limitation, to a method step comprising at least one imaging process. The term “imaging” as used herein is a broad term and is to be given its ordinary and customary meaning to a person of ordinary skill in the art and is not to be limited to a special or customized meaning. The term specifically may refer, without limitation, to providing a two-dimensional or three-dimensional representation of the reflective target. The imaging may comprise of one or more of recording or capturing optical information, e.g. spatially resolved two-dimensional or even three-dimensional optical information. The imaging may comprise generating at least one image of the reflective target. The term “image” as used herein is a broad term and is to be given its ordinary and customary meaning to a person of ordinary skill in the art and is not to be limited to a special or customized meaning. The term specifically may refer, without limitation, to data recorded by using the imaging device, such as a plurality of electronic readings from the imaging device, such as the pixels of the camera chip.

The term “imaging device” as used herein is a broad term and is to be given its ordinary and customary meaning to a person of ordinary skill in the art and is not to be limited to a special or customized meaning. The term specifically may refer, without limitation, to a device having at least one imaging element configured for recording or capturing spatially resolved one-dimensional, a two-dimensional or even three-dimensional optical information. The imaging device may be at least one device selected from the group consisting of: at least one camera, at least one CCD camera, at least one CMOS camera, at least one RGB camera, at least one digital camera, at least one camera of a microscope, at least one camera of an incident light microscope. The imaging device generally may comprise a one-dimensional or two-dimensional array of image sensors, such as pixels. The imaging device, besides at least one camera chip or imaging chip, may comprise further elements, such as one or more optical elements, e.g. one or more lenses. As an example, the imaging device may be a fix-focus camera, having at least one lens which is fixedly adjusted with respect to the camera. Alternatively, however, the imaging device may also comprise one or more variable lenses which may be adjusted, automatically or manually.

The method may comprise loading the reflective target into the laser desorption mass spectrometer. The imaging step may be performed before and/or after loading the reflective target into the laser desorption mass spectrometer.

The term “target” as used herein is a broad term and is to be given its ordinary and customary meaning to a person of ordinary skill in the art and is not to be limited to a special or customized meaning. The term specifically may refer, without limitation, to an arbitrary article, device or element which is exposed or exposable to a beam, specifically a laser beam. As an example, the target may be configured as a solid target having a predefined shape, such as a flat target disc or wafer having flat target surface and e.g. having a round, oval or polygonal shape. Specifically, the target may be exposed or may be exposable to a laser beam of a laser of a mass spectrometer, specifically of a laser desorption mass spectrometer. The target may specifically be a reusable target. The term “reusable target” as used herein is a broad term and is to be given its ordinary and customary meaning to a person of ordinary skill in the art and is not to be limited to a special or customized meaning. The term specifically may refer, without limitation, to an arbitrary target which may be configured for being used more than one time. As will be outlined in further detail below, a preparing of last one sample for analysis in a laser desorption mass spectrometer may include an applying at least one sample to the target. After conducting at least one measurement, the target, specifically a surface of the target, may be cleaned, e.g. the sample may be removed. Thereafter, a further sample may be applied to the target and a further measurement may be conducted.

The term “reflective target” as used herein is a broad term and is to be given its ordinary and customary meaning to a person of ordinary skill in the art and is not to be limited to a special or customized meaning. The term specifically may refer, without limitation, to an arbitrary target having at least one reflective interface, specifically at least one reflective surface. The reflective interface or the reflective surface may be configured for changing a direction of a wavefront between two different media so that the wavefront returns into the medium from which it originates. The reflection may specifically refer to a reflection of light. The reflective target may have a specular reflection of ≥45%. The specular reflection may refer to a phenomenon of reflection of parallel light beams falling at equal angles on a surface. Specular reflection commonly follows all three laws of reflection, i.e. an angle of reflection is equal to an angle of incidence, a normal light beam, an incident light beam and a reflected light beam all lie at the same plane. The incident ray and the reflected light beam lie on other sides of the normal light beam.

The reflective target may specifically have a smooth surface. The reflective target, specifically a surface of the reflective target, may specifically have a nominal arithmetic roughness of Rₐ≤2 μm.

The reflective target may specifically have a thickness of 0.2 mm to 1 cm, preferably 0.5 mm to 3 mm. Further, the reflective target may have a thickness of less than 1 cm, preferably of less than 3 mm. However, also other dimensions may be feasible.

In the following, an example of the reflective target is described. However, also other kinds of reflective targets may be feasible such as different kinds of materials and/or coatings of the reflective target.

The reflective target may have the at least one surface. The surface may be covered at least partially with at least one layer. The layer may be a hydrogen comprising, silicon-incorporated amorphous carbon (a-C:H:Si) layer. The a-C:H:Si layer may comprise:
40 at. % to 80 at. % of carbon;
1 at. % to 20 at. % of hydrogen; and
10 at. % to 40 at. % of silicon.

A sum of carbon, hydrogen and silicon may be up to 100%, specifically 100%. However, the a-C:H:Si layer may also comprise additional elements. Thus, the sum of carbon, hydrogen and silicon may be less than 100%. Specifically, the sum of carbon, hydrogen and silicon may be at least 51%, specifically at least 55%, specifically at least 60%, specifically at least 65%, specifically at least 70%, specifically at least 75%, specifically at least 80%, specifically at least 85%, specifically at least 90%, specifically at least 95%, specifically at least 98%.

The term “surface” as used herein is a broad term and is to be given its ordinary and customary meaning to a person of ordinary skill in the art and is not to be limited to a special or customized meaning. The term specifically may refer, without limitation, to an entirety of areas which delimit an arbitrary body from the outside. Thus, the body may have a plurality of surfaces. The term “layer” as used herein is a broad term and is to be given its ordinary and customary meaning to a person of ordinary skill in the art and is not to be limited to a special or customized meaning. The term specifically may refer, without limitation, to an amount of material which is deposited on a surface of an arbitrary element. The layer may specifically be a coating. The layer may cover the object completely or may only cover a part or parts of the object. The layer may specifically have a lateral extension exceeding its thickness by at least a factor of 2, at least a factor of 5, at least a factor of 10, or even at least a factor of 20 or more. Specifically, the a-C:H:Si layer may have a thickness of: 100 nm to 10 μm, preferably 500 nm to 1.5 μm. However, also other dimensions may be feasible.

The term “being at least partially covered” as used herein is a broad term and is to be given its ordinary and customary meaning to a person of ordinary skill in the art and is not to be limited to a special or customized meaning. The term specifically may refer, without limitation, to a property of an arbitrary element of being fully or partially covered with something. Specifically, a surface of the arbitrary element may be fully or partially covered with something. In case the surface is partially covered with something, the covered surface may also be referred to as surface section. As further used herein, the term “surface section” may refer to a part, specifically to a distinct part, of a surface. Exemplarily, the term surface section may refer to at least 5%, at least 10%, at least 20%, at least 30%, at least 40%, at least 50%, at least 60%, at least 70%, at least 80%, at least 90%, at least 95% of the surface. However, other embodiments may be feasible. The layer may specifically form a continuous layer covering a surface section or even a whole surface of the reflective target, specifically of the substrate of the reflective target.

The term “hydrogen comprising, silicon-incorporated amorphous carbon (a-C:H:Si) layer” as used herein is a broad term and is to be given its ordinary and customary meaning to a person of ordinary skill in the art and is not to be limited to a special or customized meaning. The term specifically may refer, without limitation, to an amorphous carbon layer, which comprises hydrogen and silicon. The hydrogen and/or the silicon, specifically, may be embedded or dispersed in the carbon layer without, however, being bound to the carbon by covalent chemical binding. The a-C:H:Si layer may specifically be an amorphous silicon-incorporated diamond-like carbon layer. The amorphous silicon-incorporated diamond-like carbon may have structural, mechanical, electrical, optical, chemical, and/or acoustic properties similar to those of diamond. Specifically, the amorphous silicon-incorporated diamond-like carbon may be a metastable form of amorphous carbon comprising sp³ hybridized carbon atoms. More specifically, in the amorphous silicon-incorporated diamond-like carbon, the carbon may exist in three hybridizations, sp³, sp², and sp¹. The physical properties of the amorphous silicon-incorporated diamond-like carbon as described above may derive from its mixture of carbon bonds. Specifically, the sp³ hybridization, as in diamond, may have a strong a bond, which may lead to a high mechanical hardness and chemical inertness. The sp² hybridization, as in graphite, may have a strong intralayer a bond and a weak van der Waals bond between its layers. The physical properties may specifically depend on a ratio of sp² to sp³ bonds.

The a-C:H:Si layer may specifically be a hydrogen comprising, heteroatom modified, silicon-incorporated amorphous carbon (a-C:H:Si:X) layer. The heteroatom X may be selected from the group consisting of oxygen, nitrogen, fluorine, boron and the a-C:H:Si:X layer may further comprise:
up to 15 at. % of oxygen;
up to 10 at. % of nitrogen;
up to 10 at. % of boron; and
up to 5 at. % of fluorine;

A sum of oxygen, nitrogen, fluorine and boron may be at least 1 at. %, specifically at least 1.5 at. %, specifically at least 2 at. %.

A sum of carbon, hydrogen, silicon, oxygen, nitrogen, fluorine and boron specifically may be 100 at. %. However, the a-C:H:Si:X layer may also comprise additional elements. Thus, the sum of carbon, hydrogen, silicon, oxygen, nitrogen, fluorine and boron specifically may be less than 100 at. %. Thus, the sum of carbon, hydrogen, silicon, oxygen, nitrogen, fluorine and boron may be at least 52 at. %, specifically at least 55 at. %, specifically at least 60 at. %, specifically at least 65 at. %, specifically at least 70 at. %, specifically at least 75 at. %, specifically at least 80 at. %, specifically at least 85 at. %, specifically at least 90 at. %, specifically at least 95 at. %, specifically at least 98 at. %. Also other heteroatoms may be feasible. The heteroatom may specifically be selected from the group consisting of: a metalloid, specifically germanium, specifically antimony, specifically selenium, specifically, tellurium; a post-transition metal, specifically aluminum; a transition metal, specifically titanium, specifically vanadium, specifically niobium, specifically tantalum, specifically chromium, specifically molybdenum, specifically tungsten, specifically iron, specifically cobalt, specifically copper, specifically silver; a nonmetal, specifically phosphorus, specifically sulfur, specifically chlorine, specifically bromine, specifically iodine.

The term “hydrogen comprising, silicon-incorporated, heteroatom modified, amorphous carbon (a-C:H:Si:X) layer” as used herein is a broad term and is to be given its ordinary and customary meaning to a person of ordinary skill in the art and is not to be limited to a special or customized meaning. The term specifically may refer, without limitation, to an amorphous carbon layer, which comprises hydrogen and silicon and which further, besides hydrogen and silicon, also comprises one or more kinds of heteroatoms. The hydrogen, the silicon, as well as the heteroatoms, specifically, may be embedded or dispersed in the carbon layer without, however, being bound to the carbon by covalent chemical binding. The a-C:H:Si:X layer may specifically be an amorphous heteroatom modified silicon-incorporated diamond-like carbon layer. The term “heteroatom” may refer to any atom that differs from carbon or hydrogen. As outlined above, the heteroatom is selected from the group consisting of: oxygen, nitrogen, fluorine, boron. However, also other heteroatoms may be feasible. The heteroatom may specifically be selected from the group consisting of: a metalloid, specifically germanium, specifically antimony, specifically selenium, specifically, tellurium; a post-transition metal, specifically aluminum; a transition metal, specifically titanium, specifically vanadium, specifically niobium, specifically tantalum, specifically chromium, specifically molybdenum, specifically tungsten, specifically iron, specifically cobalt, specifically copper, specifically silver; a nonmetal, specifically phosphorus, specifically sulfur, specifically chlorine, specifically bromine, specifically iodine.

The expression “at. %” may specifically refer to an indication of a percentage of atoms in a chemical substance. The percentage of atoms may be calculated by dividing a number of all atoms of a kind of element by a number of all atoms within the chemical substance. Thereafter, the result may be multiplied with 100.

The reflective target may specifically comprise at least one substrate. The term “substrate” as used herein is a broad term and is to be given its ordinary and customary meaning to a person of ordinary skill in the art and is not to be limited to a special or customized meaning. The term specifically may refer, without limitation, to an arbitrary flat element, such as a flat element having a lateral extension exceeding its thickness by at least a factor of 2, at least a factor of 5, at least a factor of 10, or even at least a factor of 20 or more. The substrate may have an arbitrary shape. Specifically, the substrate may have a round, oval or polygonal shape, such as a rectangular or round shape. Further, as will be described in further detail below, the substrate may have a strip-shape. However, also other shapes may be feasible.

The substrate may be made of at least one electrically conductive material or may comprise at least one layer of the at least one electrically conductive material. The electrically conductive material may specifically have a sheet resistance which is smaller than or equal to 100 Ω/sq, preferably smaller than or equal to 60 Ω/sq. Thus, exemplarily, the substrate may be made of the least one electrically conductive material and the a-C:H:Si layer may be deposited on the surface of the substrate.

Further, exemplarily, the substrate may be made of at least one electrically insulating material or of the at least one electrically conductive material and at least one layer of at least one electrically conductive material may be deposited on the substrate. In case the reflective target has the at least one surface being at least partially covered with the at least one layer being a-C:H.Si layer, the a-C:H:Si layer may be deposited on a surface of the layer of the at least one electrically conductive material. Thus, the a-C:H:Si layer may form an outermost layer of the reflective target. The layer of the at least one electrically conductive material may form an intermediate layer of the reflective target. Further, the reflective target may comprise a layer structure having the at least one a-C:H:Si layer and the at least one layer of the at least one electrically conductive material. Specifically, the layer structure may comprise a plurality of the layers of the at least one electrically conductive material. The plurality of the layers of the at least one electrically conductive material may form intermediate layers of the reflective target. Further, the layer structure may comprise one or more layers of at least one electrically insulating material. The layer of the at least one electrically conductive material may also be referred to as electrically conductive contact layer. The surface of the substrate or the surface of the layer of the at least one electrically conductive material on which the a-C:H:Si layer may be deposited may enable a good bonding of the a-C:H:Si layer to the surface of the substrate or to the surface of the layer of the at least one electrically conductive material. Exemplarily, the substrate may be made of glass and the electrically conductive material may be indium tin oxide (ITO). Thus, the substrate being made of glass may comprise at least one ITO layer and the a-C:H:Si layer may be deposited on a surface of the ITO layer. Further, a pretreatment, specifically a plasma treatment, of the surface of the substrate and/or of the intermediate layer may be conducted before the a-C:H:Si layer is deposited, specifically in order to increase an adhesion of the a-C:H:Si layer on the substrate.

The substrate of the reflective target may at least partially be made of at least one material or may comprise at least one material which is selected from the group consisting of: glass; steel, specifically stainless steel; aluminum; silicon; germanium titanium; copper; cobalt; chromium; molybdenum; nickel; tungsten; tantalum; graphite; a polymeric material, specifically polyethylene, specifically polypropylene, specifically polycarbonate, specifically polystyrene, specifically polyacrylate. Further, the polymeric material may be a conductive polymeric material, specifically polyaniline, specifically poly(3,4-ethylenedioxythiophene) polystyrene sulfonate, specifically polypyrrole, specifically polythiophene. Also other materials may be feasible such as alloys which comprise at least one of the metals as outlined above and at least one further element.

A substrate having a surface which is covered at least partially with at least one layer comprising hydrogen comprising, silicon-incorporated amorphous carbon (a-C:H:Si) is commercially available from e.g. CeWOTec GmbH (Chemnitzer Werkstoff-und Oberflåchentechnik, Chemnitz, Germany). CeWOTec GmbH provides a “technical data sheet for our XLC-PURA coating” including the information according to the following Table 1. The technical data sheet originates from Jan. 21, 2016 and the information is provided in the German language. The following table comprises a translation of the text into the English language.

| | |
|---|---|
| nomenclature name | a-C:H:Si:X (amorphous, hydrogen |
| according to VDI 2840 | comprising carbon, modified with silicon |
| | and further non-metallic elements, |
| | completely free of metals) |
| layer structure | gradient layer |
| manufacturing method | PACVD, process temperature about |
| | 100-200° C. |
| maximal component size | Ø 650 × 500 mm², max. 50 kg (more on |
| | request) |
| layer thickness | typically 0.5 to 1.5 μm |
| layer hardness | about 800-1.200 HK 0.05 |
| friction coefficient, dry | 0.03-0.15 (decreases with increasing |
| sliding against steel or | surface pressure and sliding speed) |
| carbide at a temperature | |
| of T < 100° C. | |
| normalized wear resistance | 0.1-0.5 MJ/mm³, depending on the degree |
| during dry sliding against | of modification and conditions of use |
| steel or carbide | |
| adhesive strength on steel | HF2-HF4, depending on the surface |
| according to VDI 3198 | preparation |
| temperature resistance | about 450° C. |
| in air | |
| intrinsic roughness | Rz < 0.05 μm (topographically true) |
| particularities | good non-stick behavior towards |
| | PUR, PI |
| | small change in dimension over the |
| | service life |
| | corrosion inhibiting |
| | very good chemical resistance |
| | moderate residual compressive |
| | stresses |
| | inner surfaces cannot be coated or only |
| | to a limited extent |
| coloring | iridescent (rainbow-colored) or light |
| | brown transparent |
| typical applications | as a wear-resistant demoulding aid when |
| | processing PUR (thermoset or TPE) and PI |
| coatable materials | steel |
| (examples) | aluminum materials |
| | titan materials |
| | hard metals |
| | co- alloys |
| non-coatable materials | precious and nonferrous metals, nickel, |
| (examples) | zinc, tin, lead |

As further outlined above, an elemental composition of the a-C:H:Si:X layer can be specified in 40 at. % to 80 at. % of carbon; 1 at. % to 20 at. % of hydrogen; 10 at. % to 40 at. % of silicon; up to 15 at. % of oxygen; up to 10 at. % of nitrogen; up to 10 at. % of boron; and up to 5 at. % of fluorine. As outlined above, a sum of oxygen, nitrogen, fluorine and boron is at least 1 at. %. Thus, the a-C:H:Si:X layer may comprise at least 1 at. % of one of the heteroatoms or some or all of the heteroatoms. Specifically, the sum of oxygen, nitrogen, fluorine and boron may be at least 5 at. %, preferably at least 10 at. %.

As outlined above, the a-C:H:Si layer may comprise up to 15 at. % of oxygen. Specifically, a percentage of oxygen may vary within the a-C:H:Si layer. The closer a region of the a-C:H:Si layer is to the surface of the reflective target, the lower may be the percentage of oxygen. Thus, within the a-C:H:Si layer, the percentage of oxygen may continuously or discontinuously decrease in a direction perpendicular to the surface of the reflective target, i.e. the surface which is exposed to the laser radiation. In a bulk region of the a-C:H:Si layer the percentage of oxygen may be less than 1 at. %, specifically less than 0.1 at. %, more specifically less than 0.01 at. %.

As outlined above, the a-C:H:Si layer may be an amorphous layer. The term “amorphous layer” as used herein is a broad term and is to be given its ordinary and customary meaning to a person of ordinary skill in the art and is not to be limited to a special or customized meaning. The term specifically may refer, without limitation, to an arbitrary layer being made of at least one material which lacks a long-range order. Thus, atoms of the material may form an irregular pattern and may only have a short-range order. However, the material may also have an internal structure made of interconnected structural blocks. The interconnected structural blocks may correspond to crystalline phase of the material.

Specifically, the a-C:H:Si layer may form an outermost layer of the reflective target which may specifically face an outer environment of the reflective target. Further, the a-C:H:Si layer may form a continuous layer on the surface of the reflective target. Further, a structural shape of a surface of the a-C:H:Si layer may resemble a shape of the surface of the substrate. Specifically, on a smooth substrate, the a-C:H:Si layer may also form a continuous and smooth surface with only low numbers of defect positions.

Specifically, the a-C:H:Si layer may be deposited on the surface of the reflective target by a plasma-supported surface coating process. Specifically, the plasma-supported surface coating process may be a plasma assisted chemical vapor deposition process (PA-CVD). The PA-CVD may be performed by a process temperature of 100° C. to 200° C. The term “plasma assisted chemical vapor deposition” may generally refer to a deposition method wherein a substrate is exposed to one or more volatile precursors which react and/or decompose on a surface of the substrate to produce a desired deposit. However, also other deposition methods may be feasible.

As outlined above, the step b) corresponds to at least one sample recognition step comprising localizing the at least one sample region on the reflective target.

The term “sample recognition step” as used herein is a broad term and is to be given its ordinary and customary meaning to a person of ordinary skill in the art and is not to be limited to a special or customized meaning. The term specifically may refer, without limitation, to a method step comprising localizing the sample region on the reflective target. The term “sample region” as used herein is a broad term and is to be given its ordinary and customary meaning to a person of ordinary skill in the art and is not to be limited to a special or customized meaning. The term specifically may refer, without limitation, to at least one region on the reflective target comprising the sample. The reflective target may comprise at least one region on which the sample is situated, e.g. on which the sample was applied. The reflective target may comprise at least one other region without the sample. The term “localizing at least one sample region” as used herein is a broad term and is to be given its ordinary and customary meaning to a person of ordinary skill in the art and is not to be limited to a special or customized meaning. The term specifically may refer, without limitation, to identifying the sample region on the reflective target.

For example, the sample recognition step may comprise localizing the sample region on the reflective target manually. For example, the localizing may comprise determining the sample region on the image of the reflective target imaged in step a) by a user.

For example, step b) may be performed automatically, e.g. without user interaction. The sample region may be localized on the reflective target using at least one image evaluation algorithm on the image of the reflective target imaged in step a) by using at least one processing device. The term “processing device” as used herein is a broad term and is to be given its ordinary and customary meaning to a person of ordinary skill in the art and is not to be limited to a special or customized meaning. The term specifically may refer, without limitation, to an arbitrary logic circuitry configured for performing basic operations of a computer or system, and/or, generally, to a device which is configured for performing calculations or logic operations. The processing device may be configured for processing basic instructions that drive the computer or system. As an example, the processing device may comprise at least one arithmetic logic unit (ALU), at least one floating-point unit (FPU), such as a math co-processor or a numeric co-processor, a plurality of registers, specifically registers configured for supplying operands to the ALU and storing results of operations, and a memory, such as an L1 and L2 cache memory. The processing device may be a multi-core processor. The processing device may be or may comprise a central processing unit (CPU). Additionally or alternatively, the processing device may be or may comprise a microprocessor, thus specifically the processor's elements may be contained in one single integrated circuitry (IC) chip. Additionally or alternatively, the processing device may be or may comprise one or more application-specific integrated circuits (ASICs) and/or one or more field-programmable gate arrays (FPGAs) and/or one or more tensor processing unit (TPU) and/or one or more chip, such as a dedicated machine learning optimized chip, or the like. The processing device may be configured, such as by software programming, for performing one or more evaluation operations. The processing device may be configured for performing the named method step(s). Thus, as an example, the processing device may comprise a software code stored thereon comprising a number of computer instructions. The processing device may provide one or more hardware elements for performing one or more of the indicated operations and/or may provide one or more processors with software running thereon for performing one or more of the method steps.

The term “image evaluation algorithm” as used herein is a broad term and is to be given its ordinary and customary meaning to a person of ordinary skill in the art and is not to be limited to a special or customized meaning. The term specifically may refer, without limitation, to an algorithm designed for performing at least one image analysis and/or image processing in order to localize the sample region. The image evaluation algorithm may comprise one or more of the following: aligning the image via reference structure elements; applying at least one image filter; an image inversion; a selection of at least one region of interest; a background correction; a decomposition into color channels; a segmentation of the image, such as a Watershed transformation or K-means clustering. The region of interest may be determined manually by a user or may be determined automatically, such as by recognizing an object within the image. The image evaluation algorithm may comprise at least one image correction. The image correction may comprise at least one background subtraction.

The image evaluation algorithm, as an example, may make use of image recognition, such as software-based automatic image recognition and/or image recognition by machine learning processes. For example, the method may comprise applying at least one trained model such as an object classification and/or detection model on the image. The object classification and/or detection model may comprise at least one machine learning and/or deep learning architecture configured for object recognition and/or identification of an object in the image and/or classifying the detected object, in particular assigning a class label to the detection object. The object classification and/or detection model may comprise at least one convolutional neural network. The object classification and/or detection model may comprise at least one convolutional neural network selected from the group consisting of: AlexNet; Visual Geometry Group (“VGG”) Network; residual neural network (“ResNet”); You Only Look Once (“YOLO”); Convolutional Neural Network (“CNN”), such as Convolutional Neural Network for Spot Detection (“detectSpot”), GoogLeNet Convolutional Neural Network, Region-Based Convolutional Neural Network method (“R-CNN”), Region-based Fully Convolutional Network (“R-FCN”), Single Shot Detector (“SSD”), Spatial Pyramid Pooling (SPP-Net); classical classification machine learning algorithms such as k-nearest neighbors algorithm (“KNN”); support vector-machine (“SVM”).

The image evaluation algorithm may comprise identifying at least one pattern indicative of the sample in the image. The term “pattern” as used herein is a broad term and is to be given its ordinary and customary meaning to a person of ordinary skill in the art and is not to be limited to a special or customized meaning. The term specifically may refer, without limitation, to an area of the image comprising at least one arbitrary feature.

The reflective target may comprise at least one pre-defined reference structural element. The image evaluation algorithm may comprise considering information on the pre-defined reference structural element for localizing the sample region in the image. The term “pre-defined reference structural element” as used herein is a broad term and is to be given its ordinary and customary meaning to a person of ordinary skill in the art and is not to be limited to a special or customized meaning. The term specifically may refer, without limitation, to a pre-defined reference structural element having a known feature, e.g. due to a structure of the reflective target. Specifically, an ideal path of the laser irradiation may be calculated based on the reference structural element. The pre-defined reference structural element may comprise at least one geometrical structure. The geometrical structure comprises at least one element selected from the group consisting of: a circle, a hexagon, a square, a polygon, a reference cross mark, a point, a line. Further, the pre-defined reference structural element may be selected from two dimensional designs, such as a mesh, specifically a polygonal mesh, a lattice. However, also other elements may be feasible. The pre-defined reference structural element may be or may comprise markings and/or engravings on the reflective target. Specifically, the reflective target may comprise a plurality of the pre-defined reference structural elements. Thereby, exemplarily, the pre-defined reference structural elements may be arranged in a concentric manner. However, also other arrangements may be feasible. Specifically, the at least one pre-defined reference structural element may cover essentially the whole surface of the reflective target. Alternatively, the at least one pre-defined reference structural element may cover an area or a segment of the surface of the reflective target.

The image evaluation algorithm may comprise at least one pattern recognition algorithm using the information on the pre-defined reference structural element for identifying the pattern indicative of the sample in the image. The term “pattern recognition algorithm” as used herein is a broad term and is to be given its ordinary and customary meaning to a person of ordinary skill in the art and is not to be limited to a special or customized meaning. The term specifically may refer, without limitation, to object classification and/or detection model designed for identifying at least one pattern in the image. The term “identifying the pattern indicative of the sample in the image” as used herein is a broad term and is to be given its ordinary and customary meaning to a person of ordinary skill in the art and is not to be limited to a special or customized meaning. The term specifically may refer, without limitation, to a process of determining the pattern indicative of the sample in the image.

The information on the pre-defined reference structural element may be used for defining a region of interest in the image. The term “region of interest” as used herein is a broad term and is to be given its ordinary and customary meaning to a person of ordinary skill in the art and is not to be limited to a special or customized meaning. The term may, specifically, refer, without limitation, to an arbitrary shaped region or area of the image. The region of interest may be the whole image or a section of the image. The region of interest may be a region of the image comprising or suspected to comprise at least one feature. The image may be a pixelated image comprising a plurality of pixels, e.g. arranged in an array of pixels, such as a rectangular array, having m rows and n columns, with m, n, independently, being positive integers. The region of interest may be or may comprise a group of pixels comprising an arbitrary number of pixels. The region of interest may comprise a plurality of sub-regions such as a plurality of pixels. The term “sub-region” as used herein is a broad term and is to be given its ordinary and customary meaning to a person of ordinary skill in the art and is not to be limited to a special or customized meaning. The term may, specifically, refer, without limitation, to an arbitrary part or element, in particular image elements, of the region of interest comprising at least one pixel or a group of pixels. The sub-regions may be square areas of the region of interest. Specifically, the region of interest in the image may correspond to a section of the image within or around the pre-defined reference structural element. Firstly, the at least one reference structural element may be recognized. Secondly, the pattern indicative of the sample in the image may be localized. Specifically, information on the region of interest may be transferred to the control device. The laser irradiation may be steered on an area of the reflective target corresponding to the region of interest by using the control device.

The image of the reflective target imaged in step a) may be additionally transferred into a structural element prior to conducting step c). Firstly, the at least one image evaluation algorithm may be used on the image of the reflective target. Specifically, a processed image of the reflective target may be obtained. The processed image may exemplarily refer to a black/white image. Secondly, specifically as an additional step, the image of the reflective target, specifically the processed image of the reflective target, may be transferred into the structural element. The structural element may specifically be selected from the group consisting of: a mesh, specifically a polygonal mesh; a lattice. Specifically, in step c) at least one of a path of the laser irradiation, a movement path of the reflective target, a movement path of a holder of the reflective target, and, optionally, at least one of a laser power and a laser focus may be calculated based on the structural element. Thus, a directed laser path or a movement of the reflective target in combination with a statically aligned laser beam may be calculated. Specifically, the calculation of the laser power and/or of the laser focus may be optional in case of an automated processing.

The method may further comprise at least one failsafe step. In case no sampled region is localized on the reflective target in step b), the reflective target, specifically the region of interest, may be scanned. A section or segment of the reflective target where the sample has been applied may be reconstructed based on the at least one reference structural element. Then, essentially only the region of interest may be scanned. The term “failsafe step” as used herein is a broad term and is to be given its ordinary and customary meaning to a person of ordinary skill in the art and is not to be limited to a special or customized meaning. The term may, specifically, refer, without limitation, to at least one step ensuring to prevent generating and/or determining and/or displaying unreliable or even false measurement values.

As outlined above, step c) corresponds to at least one analyte detection step comprising detecting the at least one analyte in the sample using surface assisted laser desorption ionization mass spectrometry (SALDI-MS) with the laser desorption mass spectrometer, wherein laser irradiation is applied to the reflective target by using the at least one laser source of the laser desorption mass spectrometer such that the at least one ion of the at least one analyte is generated which is detected by using at least one of the mass analyzing unit or the ion-mobility spectrometry device of the laser desorption mass spectrometer, wherein the laser irradiation is steered on the localized sample region by using the at least one control device.

The term “analyte detection step” as used herein is a broad term and is to be given its ordinary and customary meaning to a person of ordinary skill in the art and is not to be limited to a special or customized meaning. The term specifically may refer, without limitation, to an arbitrary method step including a quantitative and/or qualitative determination of at least one analyte in an arbitrary sample. The quantitative and/or qualitative determination of the analyte in the sample may be a result or an intermediate result of a detection process that may comprise at least one measurement step as well as further steps such as at least one preparation step and/or at least one analyzing step. As part of the detection process at least one measurement value may be generated, specifically a measurement value regarding the presence, absence, relative concentration or amount of the analyte in the sample.

The term “laser irradiation” as used herein is a broad term and is to be given its ordinary and customary meaning to a person of ordinary skill in the art and is not to be limited to a special or customized meaning. The term specifically may refer, without limitation, to a process of exposing an object, specifically a surface of an object, to laser light. In particular, a first portion of the object, specifically a first portion of the surface of the object, may be irradiated with at least one laser beam and a second portion of the object, specifically a second portion of the surface of the object, may preferably not be irradiated with the at least one laser beam. Specifically, the reflective target may absorb laser energy and transfer the laser energy to molecules of the sample and desorption and ionization may occur.

The term “laser source” as used herein is a broad term and is to be given its ordinary and customary meaning to a person of ordinary skill in the art and is not to be limited to a special or customized meaning. The term specifically may refer, without limitation, to an arbitrary device which is configured for emitting light through a process of optical amplification based on a stimulated emission of electromagnetic radiation. Specifically, the laser may be a pulsed laser. An energy of a pulse may be in a range of less than 60 μJ, specifically in a range of less than 35 μJ. Further, the laser may have a laser repetition rate in the range of 500 Hz to 5 kHz, specifically of 1 kHz to 3 kHz. For example, the laser may be configured for generating a laser beam in the UV spectral range. Specifically, a laser wavelength may be in the range between 300 nm to 400 nm. More specifically, the laser may be a neodymium-doped yttrium aluminum garnet laser (Nd:YAG laser) having a wavelength of 355 nm. Also other kinds of laser sources may be feasible. Further, the lacer source may comprise one or more further optical elements such as variable mirrors, lenses, polarizers and/or shutters.

The term “mass analyzing unit” as used herein is a broad term and is to be given its ordinary and customary meaning to a person of ordinary skill in the art and is not to be limited to a special or customized meaning. The term specifically may refer, without limitation, to an apparatus configured for detecting incoming ions. The mass analyzing unit may be configured for detecting charged particles. The mass analyzing unit may be or may comprise at least one electron multiplier. The mass analyzing unit may be configured for determining at least one mass spectrum of the detected ions. As used herein, the term “mass spectrum” is a broad term and is to be given its ordinary and customary meaning to a person of ordinary skill in the art and is not to be limited to a special or customized meaning. The term specifically may refer, without limitation, to a two-dimensional representation of signal intensity vs the mass-to-charge ratio m/z, wherein the signal intensity corresponds to abundance of the respective ion. The mass-to-charge ratio may refer to a reciprocal of a specific charge. The mass spectrum may be a pixelated image. For determining resulting intensities of pixels of the mass spectrum, signals detected with the mass analyzing unit within a certain m/z range may be integrated. The mass analyzing unit may comprise at least one evaluation device. The analyte in the sample may be identified by the at least one evaluation device. Specifically, the evaluation device may be configured for correlating known masses to the identified masses or through a characteristic fragmentation pattern.

The term “ion-mobility spectrometry device” as used herein is a broad term and is to be given its ordinary and customary meaning to a person of ordinary skill in the art and is not to be limited to a special or customized meaning. The term specifically may refer, without limitation, to an arbitrary analytical technique which is configured to separate and identify ionized molecules in a gas phase based on their mobility in a carrier buffer gas and in the presence of an electric field. The ion-mobility spectrometry device may specifically be coupled to the laser desorption mass spectrometer, specifically in order to achieve a multi-dimensional separation. The ion-mobility spectrometry device may be configured for detecting at least one drift time of the ion through the ion-mobility spectrometry cell.

The method further may comprises at least one sample preparation step. The term “sample preparation step” as used herein is a broad term and is to be given its ordinary and customary meaning to a person of ordinary skill in the art and is not to be limited to a special or customized meaning. The term specifically may refer, without limitation, to at least one process of preparing a sample for subsequent measurement. The sample preparation step may comprise at least one workflow. The workflow may comprise a single step or a plurality of subsequently and/or in parallel performed steps. The sample preparation may comprise sample purification and/or sample dilution and/or sample concentration. The sample may be subjected to one or more pretreatment and/or a sample preparation step(s). The sample may be pretreated by physical and/or chemical methods, for example by centrifugation, filtration, mixing, homogenization, chromatography, purification precipitation, dilution, concentration, contacting with a binding and/or detection reagent, and/or any other method deemed appropriate by the skilled person.

The sample preparation step may comprise applying the sample to the at least one reflective target, wherein the sample comprises the at least one analyte. Specifically, the sample may be applied to the at least one reflective target as a fluid sample. Optionally, the sample preparation step may comprise drying of the sample on the reflective target. The drying may refer to a natural drying of the sample, e.g. a drying in the open air. As part of the drying process some or all of the liquid of the sample may evaporate.

Specifically, a volume of 0.01 μl to 10 μl, preferably of 0.05 μl to 5 μl and most preferably of 0.75 μl to 2 μl may be applied to the reflective target. However, also other volumes may be feasible.

Specifically, an amount of the analyte on one sample spot may be less than 35 nmol, specifically less than 3.5 nmol, specifically less than 350 μmol, specifically less than 35 μmol, specifically less than 3.5 μmol, specifically less than 350 fmol. However, also other amounts may be feasible.

In a further aspect of the present invention, a system comprising at least one laser desorption mass spectrometer is disclosed.

The laser desorption mass spectrometer comprises at least one reflective target. At least one sample is applicable on the reflective target. The sample comprises at least one analyte. The laser desorption mass spectrometer is configured for detecting the at least one analyte in the sample using surface assisted laser desorption ionization mass spectrometry (SALDI-MS). The laser desorption mass spectrometer comprises at least one laser source. The laser source is configured for applying laser irradiation to the reflective target such that at least one ion of the at least one analyte is generated. Specifically, the application of laser irradiation to the reflective target may comprise adjusting at least one of a path of the laser irradiation, a movement path of the reflective target, a movement path of a holder of the reflective target, and, optionally, at least one of a laser power and a laser focus. The laser desorption mass spectrometer comprises at least one of a mass analyzing unit or an ion-mobility spectrometry device configured for detecting said ion. The system comprises at least one imaging device configured for imaging the reflective target. The laser desorption mass spectrometer comprises at least one control device configured for steering the laser irradiation on the localized sample region.

The term “system” as used herein is a broad term and is to be given its ordinary and customary meaning to a person of ordinary skill in the art and is not to be limited to a special or customized meaning. The term specifically may refer, without limitation, to a group of at least two elements which may interact with each other in order to fulfill at least one common function. The at least two components may be handled independently or may be coupled, connectable or integrable in order to form a common component.

The system may be configured for performing the computer-implemented method for detecting at least one analyte in a sample with a laser desorption mass spectrometer as described above or as will further be described below in more detail.

The system may comprise at least one processing device configured for using at least one image evaluation algorithm on at least one image of the reflective target imaged by the imaging device thereby localizing at least one sample region on the reflective target. For further details on the processing device, reference is made to the description above.

The reflective target may be provided as a material strip or as a stack of platelets. In case the reflective target is provided as a material strip, the reflective target may specifically be provided in a coiled manner. The material strip may be configured to be unwound before one or more samples are applied to the material strip, specifically to a surface of the material strip. The material strip may be configured to pass through the system. Specifically, the material strip may be configured to pass through different stations of the system. The different stations may comprise the laser desorption mass spectrometer and may further comprise one or more liquid handling systems and one or more vacuum zones. Further details on the liquid handling system and the vacuum zone may be provided below in more detail. The material strip may specifically be made of steel or aluminum. However, also other materials may be feasible. The material strip may have a width of 0.5 cm to 10 cm, preferably of 1 cm to 3 cm. Further, the material strip may have a thickness of 0.2 mm to 2 mm, preferably of 0.5 mm to 1 mm. Further, the material strip may have a length of 5 m to 100 m. However, also other dimensions may be feasible. Specifically, the length of the material strip may not be limited. Specifically, the material strip may be manufactured by performing a coating of the substrate during a winding process. Thus, exemplarily, the a-C:H:Si layer may be formed on the surface of the substrate during the winding process. This manufacturing process may exemplarily also be referred to as roll to roll PA-CVD coating process.

Further, as outlined above, the reflective target may be provided as a stack of platelets. The platelets may specifically have a rectangular shape such as a square shape. However, also other shapes may be feasible such as a round shape. The platelets may specifically have a thickness of 0.2 mm to 1 cm, preferably of 0.5 mm to 3 mm. Further, the platelets may have a width in the range of 1 cm to 10 cm, preferably of 1 cm to 8 cm, most preferably of 1 cm to 5 cm. Further, the platelets may have a length in the range of 1 cm to 15 cm, preferably of 1 cm to 12 cm, most preferably of 1 cm to 7 cm.

The platelets may be provided as being stacked on top of each other. Specifically, the system may comprise at least one platelet holder configured for receiving the stack of platelets. The platelet holder may be configured for releasing the platelets successively. Specifically, the system may comprise at least one conveyor belt. The platelet holder may be configured for releasing the platelets successively on the conveyor belt. The conveyor belt may be configured for successively passing the platelets through the system. Specifically, the conveyor belt may be configured for successively passing the platelets through the different stations of the system.

The system may further comprise at least one vacuum system. The system may be configured for passing the material strip or the platelets through the vacuum system. The term “vacuum system” as used herein is a broad term and is to be given its ordinary and customary meaning to a person of ordinary skill in the art and is not to be limited to a special or customized meaning. The term specifically may refer, without limitation, to an arbitrary device which is configured to create a vacuum, e.g. a region having a gaseous pressure which is below normal pressure, in a defined space such as a chamber. For this purpose, the vacuum system may comprise at least one vacuum pump. For further details on the vacuum pump, reference can be made to the description of the vacuum pump above. Specifically, the vacuum system may comprise at least one vacuum zone, preferably at least two vacuum zones. The term “vacuum zone” may refer to a defined space such as a chamber having a gaseous pressure which is below normal pressure. The at least two vacuum zones may be arranged successively. The material strip or the stack of platelets may be configured for passing the vacuum system, specifically one or more of the vacuum zones before passing the laser desorption mass spectrometer. The vacuum zone may be configured for providing an underpressure below 1500 mbar, such as to a pressure of below 1000 mbar, below 900 mbar, below 800 mbar, below 700 mbar, below 600 mbar, below 500 mbar, below 400 mbar, below 300 mbar, below 200 mbar, below 100 mbar, below 90 mbar, below 80 mbar, below 70 mbar, below 60 mbar, below 50 mbar, below 40 mbar, below 30 mbar, below 20 mbar, below 10 mbar, below 1 mbar or even less. Specifically, the at least two vacuum zones may be configured for providing underpressures which differ from one to each other. Also other parameters may be feasible. The vacuum system, specifically the vacuum zones, may be configured for drying the sample on the reflective target.

Moreover, the system may comprise the at least one liquid handling system. The liquid handling system may be configured for applying at least one sample having at least one analyte on the reflective target, specifically on the material strip or on one of the platelets. The term “liquid handling system” as used herein is a broad term and is to be given its ordinary and customary meaning to a person of ordinary skill in the art and is not to be limited to a special or customized meaning. The term specifically may refer, without limitation, to an arbitrary device which is configured for applying liquid, specifically a defined or desired amount of liquid to another object. The amount of liquid may be adjustable. The liquid handling system may specifically comprise one or more pipetting units. The pipetting unit may comprise at least one chamber being configured for holding or receiving at least one liquid. The pipetting unit may be configured for creating a partial vacuum above the chamber and for selectively releasing the partial vacuum to draw up and dispense the liquid. Further, additionally or alternatively, the liquid handling system may comprise at least one acoustic droplet ejection unit. The acoustic droplet ejection unit may be configured for using a pulse of ultrasound to move volumes of fluids without any physical contact. However, also other embodiments may be feasible.

The invention further discloses and proposes a computer program comprising instructions which, when the program is executed by the system as described above or as will further be described below in more detail, cause the system to perform the method as described above or as will further be described below in more detail. Specifically, the computer program may be stored on a computer-readable data carrier. Thus, specifically, one, more than one or even all of method steps a), b) and c) of the method as indicated above may be performed by using a computer or a computer network, preferably by using a computer program. Specifically, tables of scan parameters may be provided to an instrument software.

The invention further discloses and proposes a computer program product having program code means, in order to perform more than one or even all of method steps a), b) and c) of the method as indicated above according to the present invention in one or more of the embodiments enclosed herein when the program is executed on a computer or computer network. Specifically, the program code means may be stored on a computer-readable data carrier.

The invention further discloses and proposes a computer-readable storage medium comprising instructions which, when the instructions are executed by the system as described above or as will further be described below in more detail, cause the system to perform the method as described above or as will further be described below in more detail.

The invention further discloses and proposes a non-transient computer-readable medium including instructions that, when executed by one or more processors, cause the one or more processors to perform the as described above or as will further be described below in more detail.

Further, the invention discloses and proposes a data carrier having a data structure stored thereon, which, after loading into a computer or computer network, such as into a working memory or main memory of the computer or computer network, may execute more than one or even all of method steps a), b) and c) of the method as indicated above according to one or more of the embodiments disclosed herein.

The invention further proposes and discloses a computer program product with program code means stored on a machine-readable carrier, in order to perform more than one or even all of method steps a), b) and c) of the method as indicated above according to one or more of the embodiments disclosed herein, when the program is executed on a computer or computer network. As used herein, a computer program product refers to the program as a tradable product. The product may generally exist in an arbitrary format, such as in a paper format, or on a computer-readable data carrier. Specifically, the computer program product may be distributed over a data network.

Finally, the invention proposes and discloses a modulated data signal which contains instructions readable by a computer system or computer network, for performing more than one or even all of method steps a), b) and c) as indicated above according to one or more of the embodiments disclosed herein.

Preferably, referring to the computer-implemented aspects of the invention, more than one or even all of method steps a), b) and c) of the method as indicated above according to one or more of the embodiments disclosed herein may be performed by using a computer or computer network. Thus, generally, any of the method steps including provision and/or manipulation of data may be performed by using a computer or computer network. Generally, these method steps may include any of the method steps, typically except for method steps requiring manual work, such as providing the samples and/or certain aspects of performing the actual measurements.

Specifically, the present invention further discloses:
A computer or computer network comprising at least one processor, wherein the processor is adapted to perform more than one or even all of method steps a), b) and c) of the method according to one of the embodiments described in this description,
a computer loadable data structure that is adapted to perform more than one or even all of method steps a), b) and c) of the method according to one of the embodiments described in this description while the data structure is being executed on a computer,
a computer program, wherein the computer program is adapted to perform more than one or even all of method steps a), b) and c) of the method according to one of the embodiments described in this description while the program is being executed on a computer,
a computer program comprising program means for performing more than one or even all of method steps a), b) and c) of the method according to one of the embodiments described in this description while the computer program is being executed on a computer or on a computer network,
a computer program comprising program means according to the preceding embodiment, wherein the program means are stored on a storage medium readable to a computer,
a storage medium, wherein a data structure is stored on the storage medium and wherein the data structure is adapted to perform more than one or even all of method steps a), b) and c) of the method according to one of the embodiments described in this description after having been loaded into a main and/or working storage of a computer or of a computer network, and
a computer program product having program code means, wherein the program code means can be stored or are stored on a storage medium, for performing more than one or even all of method steps a), b) and c) of the method according to one of the embodiments described in this description, if the program code means are executed on a computer or on a computer network.

The method and devices according to the present invention provide a large number of advantages over known methods and devices.

Image based sample recognition may be coupled onto a SALDI target which is used to steer laser irradiations for the SALDI process only on the spots on which the dried analyte is present. This allows a rapid measurement of the analyte spot and supports quantitative analysis, while also reducing a data file size, specifically compared to classical measurement methods, like MALDI imaging, of predefined sample areas. Specifically, classical MALDI approaches cannot be coupled with this type of idea due to the fact that a massive matrix compound (>>10 pg) is commonly used to ionize an analyte component and therefore covers the whole spot. Thus, in classical MALDI approaches, no discrimination of matrix and analyte is usually possible.

Summarizing and without excluding further possible embodiments, the following embodiments may be envisaged:

Embodiment 1: Computer-implemented method for detecting at least one analyte in a sample with a laser desorption mass spectrometer, wherein the method comprises:
a) at least one imaging step comprising imaging at least one reflective target by using at least one imaging device, wherein the sample comprising the at least one analyte is applied to the reflective target;
b) at least one sample recognition step comprising localizing at least one sample region on the reflective target; and
c) at least one analyte detection step comprising detecting the at least one analyte in the sample using surface assisted laser desorption ionization mass spectrometry (SALDI-MS) with the laser desorption mass spectrometer, wherein laser irradiation is applied to the reflective target by using at least one laser source of the laser desorption mass spectrometer such that at least one ion of the at least one analyte is generated which is detected by using at least one of a mass analyzing unit or an ion-mobility spectrometry device of the laser desorption mass spectrometer, wherein the laser irradiation is steered on the localized sample region by using at least one control device.

Embodiment 2: The method according to the preceding embodiment, wherein the method further comprises at least one sample preparation step, wherein the sample preparation step comprises applying the sample to the at least one reflective target, wherein the sample comprises the at least one analyte.

Embodiment 3: The method according to the preceding embodiment, wherein the sample preparation step comprises drying of the sample on the reflective target.

Embodiment 4: The method according to any one of the preceding embodiments, wherein the sample region is localized on the reflective target using at least one image evaluation algorithm on the image of the reflective target imaged in step a) by using at least one processing device.

Embodiment 5: The method according to the preceding embodiment, wherein the image of the reflective target imaged in step a) is additionally transferred into a structural element prior to conducting step c).

Embodiment 6: The method according to the preceding embodiment, wherein in step c) at least one of a path of the laser irradiation, a movement path of the reflective target, a movement path of a holder of the reflective target, and, optionally, at least one of a laser power and a laser focus, is calculated based on the structural element.

Embodiment 7: The method according to any one of the three preceding embodiments, wherein the image evaluation algorithm comprises identifying at least one pattern indicative of the sample in the image.

Embodiment 8: The method according to the preceding embodiment, wherein the reflective target comprises at least one pre-defined reference structural element, wherein the image evaluation algorithm comprises considering information on the pre-defined reference structure element for localizing the sample region in the image.

Embodiment 9: The method according to the preceding embodiment, wherein the pre-defined reference structural element comprises at least one geometrical structure, wherein the geometrical structure comprises at least one element selected from the group consisting of: a circle, a hexagon, a square, a polygon, a reference cross mark, a point, a line.

Embodiment 10: The method according to any one of the two preceding embodiments, wherein the pre-defined reference structural element is selected from the group consisting of: a mesh, a lattice.

Embodiment 11: The method according any one of the two preceding embodiments, wherein the image evaluation algorithm comprises at least one pattern recognition algorithm using the information on the pre-defined reference structural element for identifying the pattern indicative of the sample in the image.

Embodiment 12: The method according to any one of the three preceding embodiments, wherein the information on the pre-defined reference structural element is used for defining a region of interest in the image.

Embodiment 13: The method according to any one of the preceding embodiments, wherein the sample recognition step comprises localizing the sample region on the reflective target manually.

Embodiment 14: The method according to any one of the preceding embodiments, wherein the computer-implemented method for detecting at least one analyte in a sample with a laser desorption mass spectrometer is conducted at least partially automatically.

Embodiment 15: The method according to the preceding embodiment, wherein at least steps a) and c) are conducted automatically.

Embodiment 16: The method according to any one of the preceding embodiments, wherein the computer-implemented method for detecting at least one analyte in a sample with a laser desorption mass spectrometer is conducted fully automatically, specifically from a sample preparation to the analyte detection step.

Embodiment 17: The method according to the preceding embodiment, wherein at least steps a), b) and c) are conducted automatically.

Embodiment 18: The method according to any one of the preceding embodiments, wherein the reflective target has a specular reflection of ≥45%.

Embodiment 19: The method according to any one of the preceding embodiments, wherein the reflective target has a nominal arithmetic roughness of Rₐ≤2 μm.

Embodiment 20: The method according to any one of the preceding embodiments, wherein the reflective target has at least one surface, wherein the surface is covered at least partially with at least one layer, wherein the layer is a hydrogen comprising, silicon-incorporated amorphous carbon (a-C:H:Si) layer, wherein the a-C:H:Si layer comprises:
40 at. % to 80 at. % of carbon;
1 at. % to 20 at. % of hydrogen; and
10 at. % to 40 at. % of silicon.

Embodiment 21: The method according to according to the preceding embodiment, wherein the a-C:H:Si layer is a hydrogen comprising, heteroatom modified, silicon-incorporated amorphous carbon (a-C:H:Si:X) layer, wherein the heteroatom X is selected from the group consisting of oxygen, nitrogen, fluorine, boron, wherein the a-C:H:Si:X layer further comprises:
up to 15 at. % of oxygen;
up to 10 at. % of nitrogen;
up to 10 at. % of boron; and
up to 5 at. % of fluorine;
   wherein a sum of oxygen, nitrogen, fluorine and boron is at least 1 at. %.

Embodiment 22: The method according to according to any one of the two preceding embodiments, wherein the a-C:H:Si layer is deposited on the surface of the target by a plasma supported surface coating process.

Embodiment 23: The method according to any one of the preceding embodiments, wherein the reflective target comprises at least one substrate, wherein the substrate is made of at least one material which is selected from the group consisting of: glass; steel, specifically stainless steel; aluminum; silicon; germanium; titanium; copper; cobalt; chromium; molybdenum, nickel; tungsten; tantalum; graphite; a polymeric material, specifically polyethylene, specifically polypropylene, specifically polycarbonate, specifically polystyrene, specifically polyacrylate, specifically polyaniline, specifically poly(3,4-ethylenedioxythiophene) polystyrene sulfonate, specifically polypyrrole, specifically polythiophene.

Embodiment 24: The method according to any one of the preceding embodiments, wherein the imaging device is at least one device selected from the group consisting of: at least one camera, at least one CCD camera, at least one CMOS camera, at least one RGB camera, at least one digital camera, at least one camera of a microscope, at least one camera of an incident light microscope.

Embodiment 25: The method according to any one of the preceding embodiments, wherein the analyte is at least one analyte selected from the group consisting of: a steroid; specifically a ketosteroid, specifically a secosteroid; a therapeutically active substance; a detergent; a glycoside; a peptide; a protein; a dye; an ion; a nucleic acid; an amino acid; a metabolite; a hormone; a fatty acid; a lipid; a carbohydrate.

Embodiment 26: The method according to any one of the preceding embodiments, wherein the analyte has a molar mass from 6 Da to 10000 Da, preferably from 50 Da to 3000 Da.

Embodiment 27: The method according to any one of the preceding embodiments, wherein the analyte comprises permanently positive charged molecules or permanently negative charged molecules.

Embodiment 28: The method according to any one of the preceding embodiments, wherein an amount of the analyte on one sample spot is less than 35 nmol, specifically less than 3.5 nmol, specifically less than 350 μmol, specifically less than 35 μmol, specifically less than 3.5 μmol, specifically less than 350 fmol.

Embodiment 29: The method according to any one of the preceding embodiments, wherein a volume of 0.01 μl to 10 μl, preferably of 0.05 μl to 5 μl and most preferably of 0.75 μl to 2 μl are applied to the reflective target.

Embodiment 30: The method according to any one of the preceding embodiments, wherein the sample is selected from the group consisting of: a physiological fluid, including blood, serum, plasma, saliva, ocular lens fluid, cerebral spinal fluid, sweat, urine, milk, ascites fluid, mucous, synovial fluid, peritoneal fluid, amniotic fluid, tissue or cells.

Embodiment 31: The method according to any one of the preceding embodiments, wherein the method comprises loading the reflective target into the laser desorption mass spectrometer, wherein the imaging step is performed before and/or after loading the reflective target into the laser desorption mass spectrometer.

Embodiment 32: The method according to any one of the preceding embodiments, wherein the method comprises at least one failsafe step, wherein in case no sampled region is localized on the reflective target in step b), the reflective target is scanned.

Embodiment 33: A system comprising at least one laser desorption mass spectrometer, wherein the laser desorption mass spectrometer comprises at least one reflective target, wherein at least one sample is applicable on the reflective target, wherein the sample comprises at least one analyte, wherein the laser desorption mass spectrometer is configured for detecting the at least one analyte in the sample using surface assisted laser de-sorption ionization mass spectrometry (SALDI-MS), wherein the laser desorption mass spectrometer comprises at least one laser source, wherein the laser source is configured for applying laser irradiation to the reflective target such that at least one ion of the at least one analyte is generated, wherein the laser desorption mass spectrometer comprises at least one of a mass analyzing unit or an ion-mobility spectrometry device configured for detecting said ion,
wherein the system comprises at least one imaging device configured for imaging the reflective target,
wherein the laser desorption mass spectrometer comprises at least one control device configured for steering the laser irradiation on the localized sample region.

Embodiment 34: The system according to the preceding embodiment, wherein the system comprises at least one processing device configured for using at least one image evaluation algorithm on at least one image of the reflective target imaged by the imaging device thereby localizing at least one sample region on the reflective target.

Embodiment 35: The system according to any one of the two preceding embodiments, wherein the system is configured for performing the method for detecting at least one analyte according to any one of the preceding claims.

Embodiment 36: The system according to any one of the three preceding embodiments, wherein the target is provided as a material strip or as a stack of platelets, wherein the system further comprises at least one vacuum system, wherein the system is configured for passing the material strip or the platelets through the vacuum system.

Embodiment 37: A computer program comprising instructions which, when the program is executed by the system according to any one of the preceding embodiments referring to a system, cause the system to perform the method according to any one of the preceding claims referring to a method.

Embodiment 38: A computer-readable storage medium comprising instructions which, when the instructions are executed by the system according to any one of the preceding claims referring to a system, cause the system to perform the method according to any one of the preceding embodiments referring to a method.

Embodiment 39: A non-transient computer-readable medium including instructions that, when executed by one or more processors, cause the one or more processors to perform the method according to any one of the preceding embodiments referring to a method.

### SHORT DESCRIPTION OF THE FIGURES

Further optional features and embodiments will be disclosed in more detail in the subsequent description of embodiments, preferably in conjunction with the dependent claims. Therein, the respective optional features may be realized in an isolated fashion as well as in any arbitrary feasible combination, as the skilled person will realize. The scope of the invention is not restricted by the preferred embodiments. The embodiments are schematically depicted in the Figures. Therein, identical reference numbers in these Figures refer to identical or functionally comparable elements.

In the Figures:

FIGS. 1A to 1B show two exemplary embodiments of a computer-implemented method for detecting at least one analyte in a sample with a laser desorption mass spectrometer according to the present invention in schematic flowcharts;

FIGS. 2A to 2B respectively show low resolution microscopy images of a dried sample on a reflective target;

FIGS. 3A to 3B respectively show mass spectra acquired with a laser desorption mass spectrometer;

FIG. 4 shows a further low resolution microscopy image of a dried sample;

FIG. 5 shows an exemplary embodiment of a laser desorption mass spectrometer according to the present invention; and

FIG. 6 shows a further exemplary embodiment of a system according to the present invention.

### DETAILED DESCRIPTION OF THE EMBODIMENTS

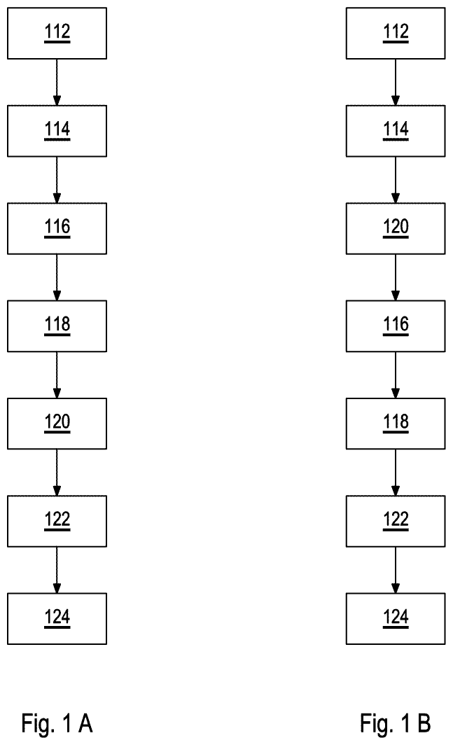

FIGS. 1A and 1B show two exemplary embodiments of a computer-implemented method for detecting at least one analyte in a sample with a laser desorption mass spectrometer according to the present invention in schematic flowcharts.

The computer-implemented method for detecting at least one analyte in a sample may comprise at least one sample preparation step. The sample preparation step may comprise an applying of the sample to the at least one reflective target. The sample may comprise the at least one analyte. The applied sample may also be referred to as a sample spot. This step is illustrated in the flow chart of FIG. 1A with box 112.

Further, the sample on the reflective target may be dried. This step is illustrated in the flow chart of FIG. 1A with box 114. The drying of the sample on the reflective target may also be part of the sample preparation step.

Further, the computer-implemented method for detecting at least one analyte in a sample comprises at least one imaging step comprising imaging the reflective target by using at least one imaging device. This step is illustrated in the flow chart of FIG. 1A with box 116.

Moreover, the computer-implemented method for detecting at least one analyte in a sample comprises at least one sample recognition step comprising localizing at least one sample region on the reflective target. This step is illustrated in the flow chart of FIG. 1A with box 118. This step may include data processing and image digitalization. Specifically, the sample region may be localized on the reflective target using at least one image evaluation algorithm on the image of the reflective target by using at least one processing device. Further, specifically, the image evaluation algorithm may comprise identifying at least one pattern indicative of the sample in the image.

Thereafter, the reflective target having the sample may be loaded onto a laser desorption mass spectrometer. This step is illustrated in the flow chart of FIG. 1A with box 120.

Further, the computer-implemented method for detecting at least one analyte in a sample comprises at least one analyte detection step comprising detecting the at least one analyte in the sample using surface assisted laser desorption ionization mass spectrometry (SALDI-MS) with the laser desorption mass spectrometer. This detecting step comprises an application of laser irradiation to the reflective target by using at least one laser source of the laser desorption mass spectrometer such that at least one ion of the at least one analyte is generated. The laser irradiation is steered on the localized sample region by using at least one control device. This step is illustrated in the flow chart of FIG. 1A with box 122. Further, the detecting step comprises detecting of the at least one ion of the at least one analyte by using at least one of a mass analyzing unit or an ion-mobility spectrometry device of the laser desorption mass spectrometer. This step may also be referred to as sample measurement step and is illustrated in the flow chart of FIG. 1A with box 124.

The computer-implemented method for detecting at least one analyte in a sample as illustrated in FIG. 1B corresponds in large parts to the computer-implemented method for detecting at least one analyte in a sample as illustrated in FIG. 1A. Thus, reference is made to the description of FIG. 1A above.

In contrast to the method as illustrated in FIG. 1A, in the method as illustrated in FIG. 1B, an order of the steps is reversed. Thus, the loading of the reflective target having the sample onto a laser desorption mass spectrometer which is illustrated in the flow chart with box 120 may be conducted before imaging the reflective target by using at least one imaging device and before localizing at least one sample region on the reflective target. These steps are illustrated in the flow chart with boxes 116 and 118.

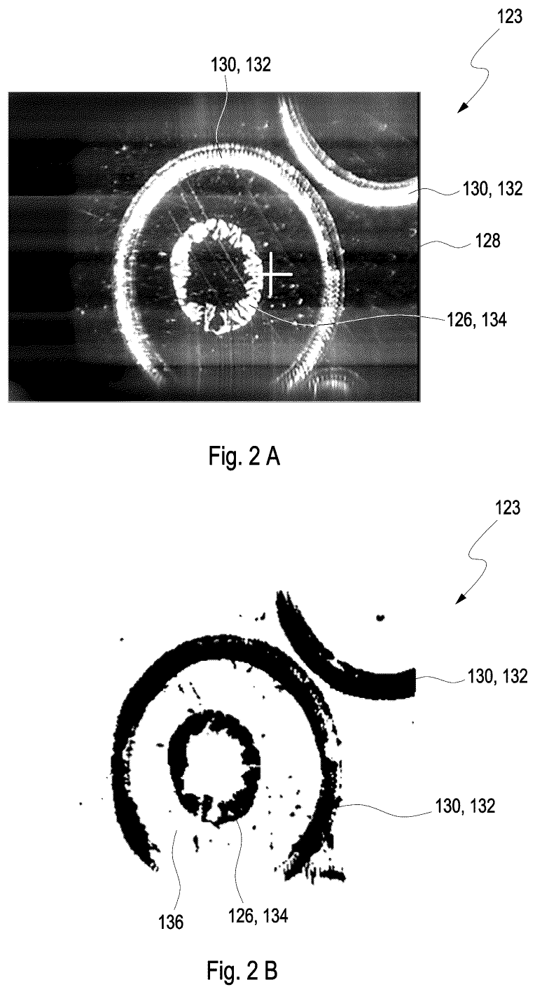

FIGS. 2A and 2B respectively show low resolution microscopy images of a dried sample 126 on a reflective target 128.

Specifically, FIG. 2A shows a low resolution microscopy image 123 of 100 ng cortisone dried from a 80% MeOH solution. The reflective target 128 may specifically comprise pre-defined reference structural elements 130. The pre-defined reference structural elements 130 may specifically comprise a plurality of circles 132. In the low resolution microscopy image a ring 134 within one of the circles 132 is visible. The ring 134 corresponds to the dried sample 126. The ring 134 may specifically exhibit the dried sample 126 with a typical coffee ring effect.

Further, FIG. 2B shows a low resolution microscopy image 123 of 100 ng cortisone dried from a 80% MeOH solution after binarization (black/white image). The circles 132 are still visible and can be used for calibration of the laser position. The ring 134 may correspond to a measuring range for the laser. Only black spots are prone for laser irritation within the circles 132. White areas 136 correspond to areas without a sample.

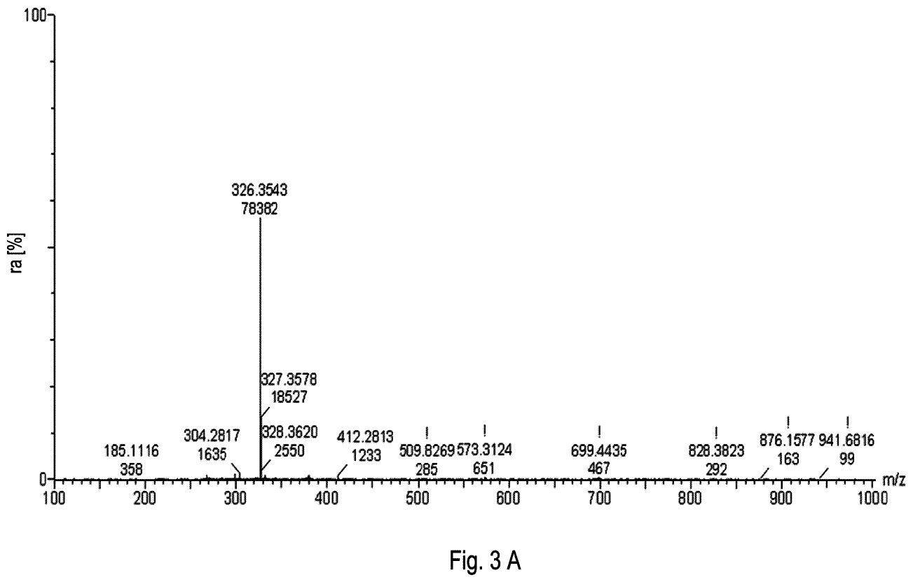

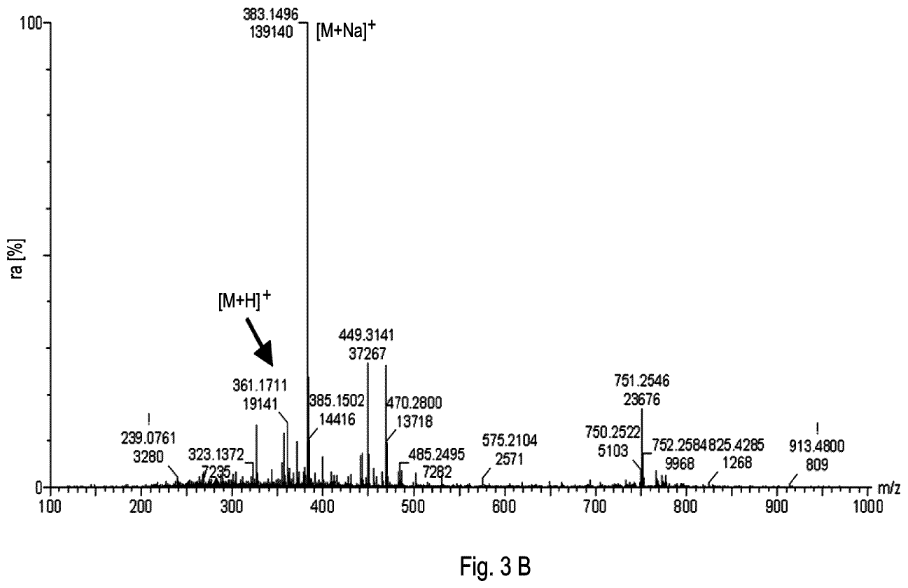

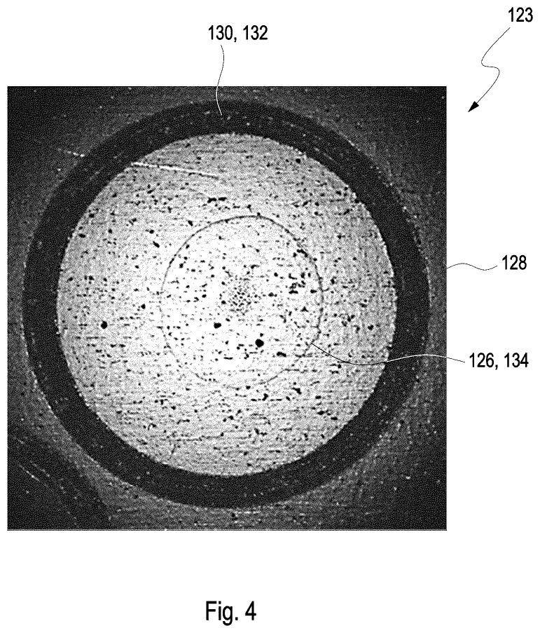

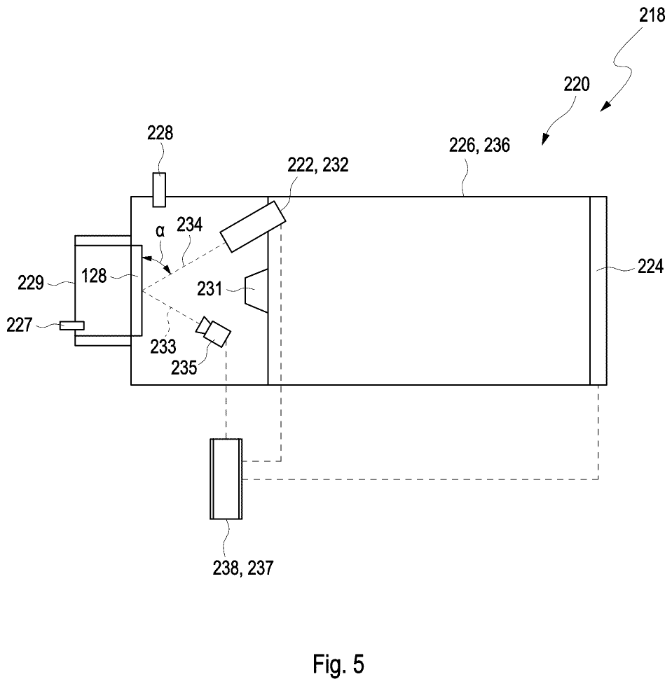

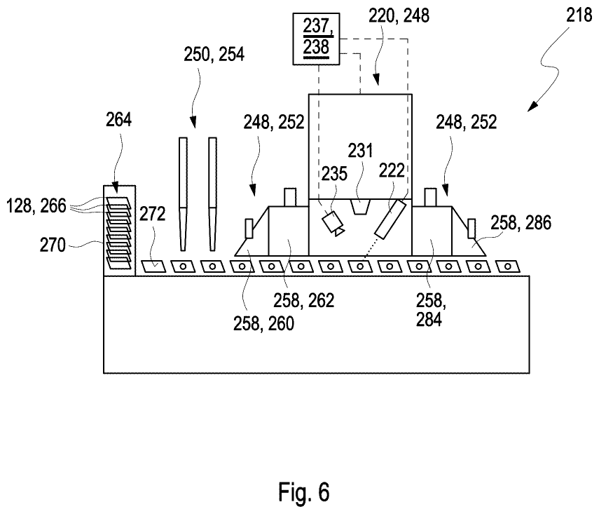

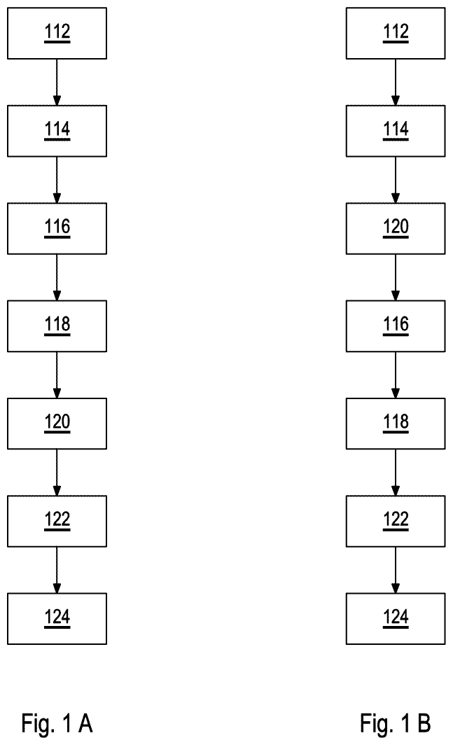

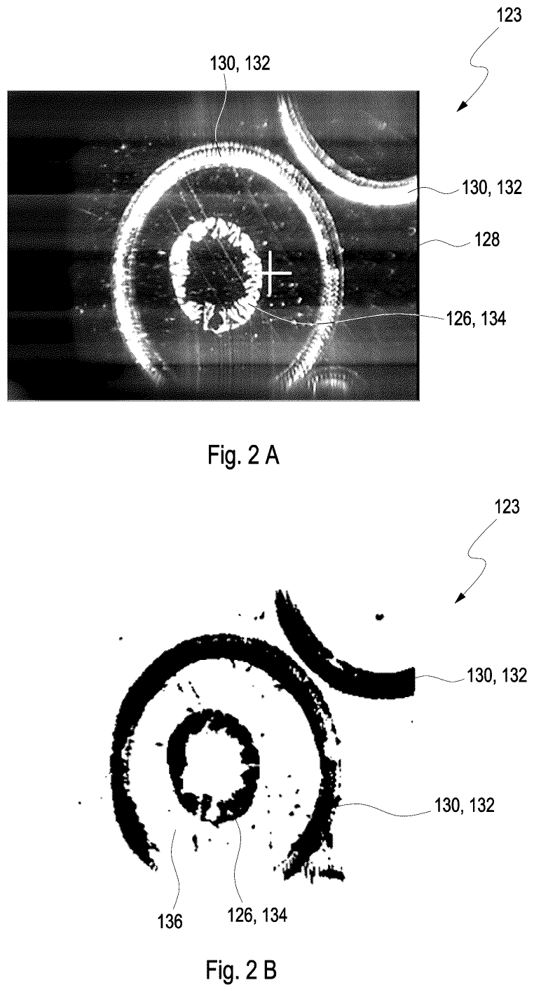

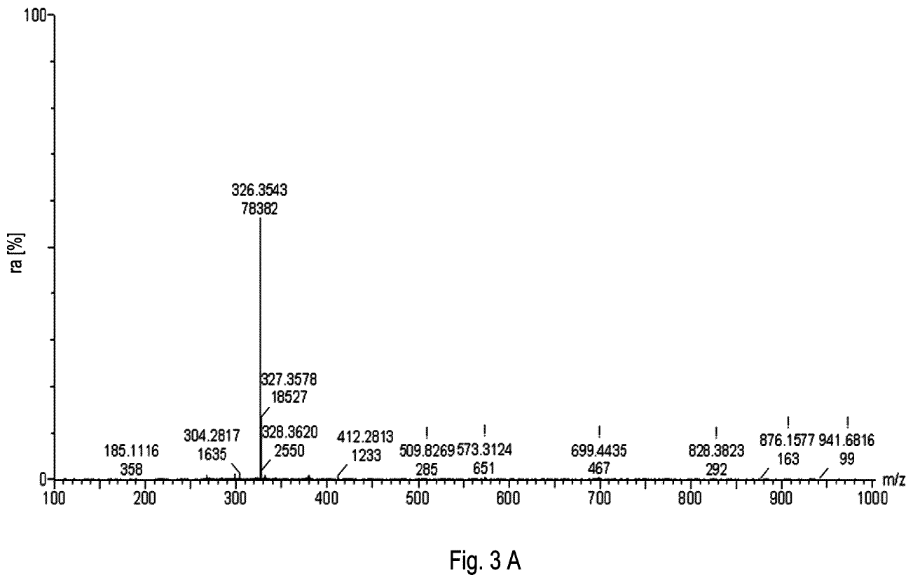

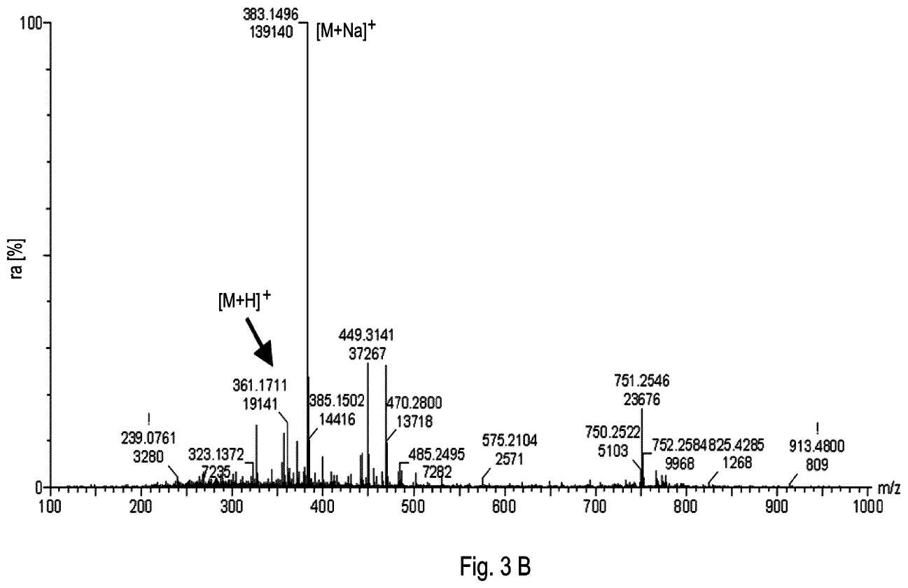

FIGS. 3A to 3B respectively show mass spectra acquired with a laser desorption mass spectrometer. The mass spectra were acquired from the reflective target 128 as illustrated in FIGS. 2A and 2B.

The mass spectra show a relative abundance ra in % in dependence of the mass-to-charge ratio m/z.

FIG. 3A shows spectra from outside the ring 134 corresponding to the dried sample 126. Thus, no analytes are present. FIG. 3B shows spectra from inside the ring 134 corresponding to the dried sample 126. Analyte signals of cortisone ([M+H]⁺ and [M+Na]⁺) are clearly visible.

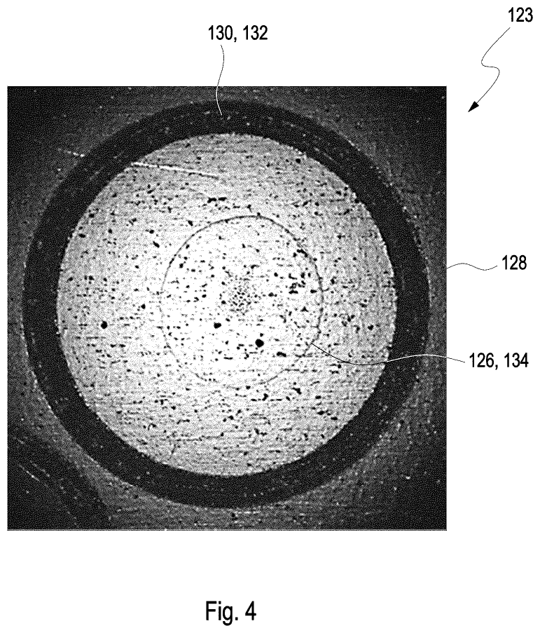

FIG. 4 shows a further low resolution microscopy image of a dried sample 126. The sample 126 corresponds to a mixture of 500 pg testosterone and 500 pg progesterone. The reflective target 128 may specifically comprise the pre-defined reference structural elements 130. The pre-defined reference structural elements 130 may specifically comprise a plurality of the circles 132. In the low resolution microscopy image the ring 134 within one of the circles 132 is visible. The ring 134 corresponds to the dried sample 126.

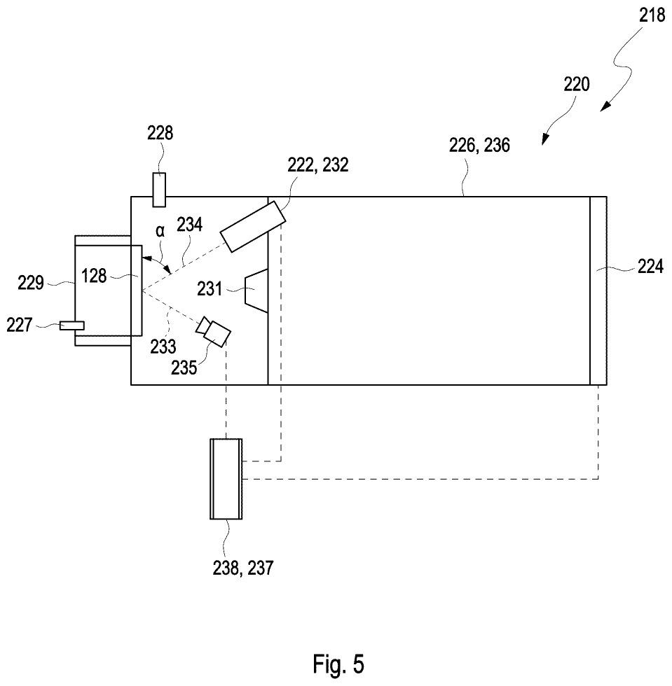

FIG. 5 shows an exemplary embodiment of a system 218 comprising a laser desorption mass spectrometer 220 according to the present invention.

The laser desorption mass spectrometer 220 comprises at least one reflective target 128. The reflective target 128 may correspond at least partially to the reflective target 128 as depicted in FIG. 2A. Thus, reference to the description of FIG. 2A above is made. Further, the laser desorption mass spectrometer 220 comprises at least one laser source 222. The laser source 222 is configured for applying laser irradiation to the reflective target 128 such that at least one ion of the at least one analyte is generated. Further, the laser desorption mass spectrometer 220 comprises at least one of a mass analyzing unit 224. Additionally or alternatively, the laser desorption mass spectrometer 220 may comprise an ion-mobility spectrometry device configured for detecting said ion. Specifically, the mass analyzing unit 224 may be configured for detecting at least one mass-to-charge ratio of the at least one ion emitted from the target 118.

The laser desorption mass spectrometer 220 may comprise at least one chamber 226. Further, the laser desorption mass spectrometer 220 may comprise at least one high-vacuum chamber 228, at least one low-vacuum chamber 227 and at least one sample loading chamber 229. At least one ion-inlet 231 may be arranged between the high vacuum chamber 228 and the chamber 226.

The laser source 222 may specifically be a pulsed laser 232. The laser source 222 may be configured for generating a laser beam in the UV spectral range. The laser source 222 may be arranged relative to the reflective target 128 such that the laser beam, which is schematically depicted with arrow 234, hits the reflective target 128 at an angle of 10° to 90°, preferably of 30° to 70°. Specifically, the reflective target 128 may absorb laser energy and transfer the laser energy to molecules of the sample and desorption and ionization may occur. Further, the system 218 may comprise at least one imaging device 235. The imaging device 235 may be arranged at an angle of 10° to 90°, preferably of 30° to 80°, relative to the reflective target 128 such as indicated with arrow 233. Specifically, the imaging device 235 may be arranged at an angle of essentially 90° relative to the reflective target 128.

Moreover, the laser desorption mass spectrometer 320 may comprise at least one mass separating module 236. A setup of the mass separating module 236 may be dependent on an applied mass spectrometry technique.

The mass analyzing unit 224 having read-out electronics 238 may be received within the chamber 226. Further, the mass analyzing unit 224 may be arranged at a certain distance to the reflective target 128. The mass analyzing unit 224 may be configured for detecting or determining at least one mass-to-charge ratio of the at least one ion emitted from the reflective target 128. Moreover, the laser desorption mass spectrometer 220 comprises at least one control device 237 configured for steering the laser irradiation on the localized sample region.

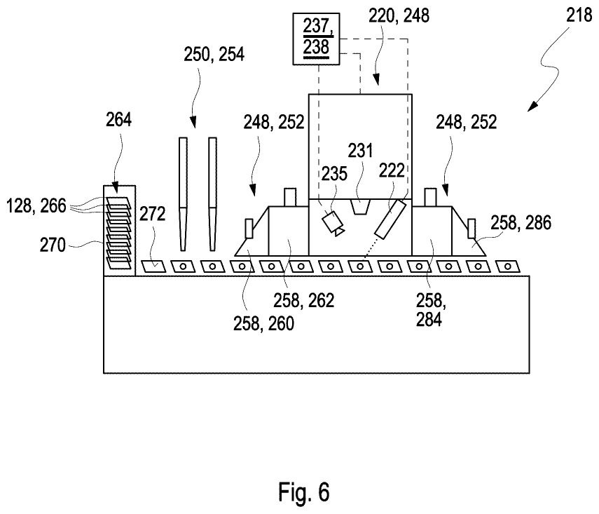

FIG. 6 shows a further exemplary embodiment of a system 218 according to the present invention.

The system 218 according to FIG. 6 comprises at least one laser desorption mass spectrometer 220. The laser desorption mass spectrometer 220 corresponds at least partially to the laser desorption mass spectrometer 220 as depicted in FIG. 5. Thus, reference to the description of FIG. 5 above is made.

FIG. 6 shows the system 218 wherein the reflective target 128 is provided as a stack 164 of platelets 266. The platelets 266 may specifically have a rectangular shape such as a square shape. The platelets 266 may be provided as being stacked on top of each other. Specifically, the platelets 266 may be stored in a platelet holder 270. The platelet holder 270 may be configured for releasing the platelets 266 successively. Specifically, the system 218 may comprise at least one conveyor belt (not shown). The platelet holder 270 may be configured for releasing the platelets 266 successively on the conveyor belt. The conveyor belt may be configured for successively passing the platelets 266 through different stations 248 of system 218.

The different stations 248 may comprise the laser desorption mass spectrometer 220 and may further comprise one or more liquid handling systems 250 and/or a vacuum system 252.

The liquid handling system 250 may be configured for applying at least one sample 268 having at least one analyte on the reflective target 128, specifically on the platelets 266. The liquid handling system 250 may specifically comprise one or more pipetting units 254. Specifically, the conveyor belt may be configured for successively passing the platelets 166 through the liquid handling system 150. After individual collection of the platelets 166 out of the stack 164 the platelets 166 may be loaded with the sample 268 comprising an analyte solution by using the pipetting unit 254. The sample 268 may be pipetted on a surface 272 of the platelets 266

Further, the conveyor belt may be configured for successively passing the platelets 266 through the vacuum system 252 and the laser desorption mass spectrometer 220. The vacuum system 252 may comprise one or more vacuum zones 258. The vacuum zones 258 may be arranged successively. The platelets 266 may be configured for passing the vacuum system 252, specifically one or more of the vacuum zones 258 before passing the laser desorption mass spectrometer 220.

Specifically, the platelets 266 may be configured for passing at least one first vacuum zone 260 and at least one second vacuum zone 262 before passing the laser desorption mass spectrometer 220. The first vacuum zone 260 may be configured for providing a first underpressure and the second vacuum zone 262 may be configured for providing a second underpressure. The first underpressure may be higher than the second underpressure or vice versa. The first underpressure and the second underpressure may be below 1500 mbar. The vacuum system 252, specifically the vacuum zones 258, may be configured for drying the sample on the reflective target 128. Further, the vacuum system 252 may comprise at least one third vacuum zone 184 and at least one fourth vacuum zone 186. Specifically, the platelets 266 may be configured for passing the at least one third vacuum zone 284 and the at least one fourth vacuum zone 286 after passing the laser desorption mass spectrometer 220. The third vacuum zone 284 and the fourth vacuum zone 286 may be configured for ensuring a continuous outward transfer and for keeping the vacuum in the laser region as low as technically possible at the same time, specifically for ensuring a reliable measurement.

The laser desorption mass spectrometer 220 may exemplarily comprise a quadrupole with subsequent ion trapping, isobaric separation via ion mobility, fragmentation in a collision cell and may be followed by quadrupole or time-of-flight (ToF) mass analysis. Other techniques of ion manipulations, like magnetic sector or ion trap, and different combinations of the corresponding units are also possible.

### LIST OF REFERENCE NUMBERS

112 box
114 box
116 box
118 box
120 box
122 box
123 low resolution microscopy image
124 box
126 dried sample
128 reflective target
130 pre-defined reference structural element
132 circle
134 ring
136 white area
218 system
220 laser desorption mass spectrometer
222 laser source
224 mass analyzing unit
226 chamber
227 low-vacuum chamber
228 high vacuum chamber
229 sample loading chamber
230 arrow
231 ion inlet
232 pulsed laser
233 arrow
234 arrow
235 imaging device
236 mass separation module
237 control device
238 read-out electronics
248 station
250 liquid handling system
252 vacuum system
254 pipetting unit
256 region
258 vacuum zone
260 first vacuum zone
262 second vacuum zone
264 stack
266 platelet
268 sample
270 platelet holder
272 surface

1. Computer-implemented method for detecting at least one analyte in a sample with a laser desorption mass spectrometer, wherein the method comprises:
a) at least one imaging step comprising imaging at least one reflective target by using at least one imaging device, wherein the sample comprising the at least one analyte is applied to the reflective target;
b) at least one sample recognition step comprising localizing at least one sample region on the reflective target; and
c) at least one analyte detection step comprising detecting the at least one analyte in the sample using surface assisted laser desorption ionization mass spectrometry (SALDI-MS) with the laser desorption mass spectrometer, wherein laser irradiation is applied to the reflective target by using at least one laser source of the laser desorption mass spectrometer such that at least one ion of the at least one analyte is generated which is detected by using at least one of a mass analyzing unit or an ion-mobility spectrometry device of the laser desorption mass spectrometer, wherein the laser irradiation is steered on the localized sample region by using at least one control device.

2. The method according to claim 1, wherein the method further comprises at least one sample preparation step, wherein the sample preparation step comprises applying the sample to the at least one reflective target, wherein the sample comprises the at least one analyte.

3. The method according to claim 1, wherein the sample region is localized on the reflective target using at least one image evaluation algorithm on the image of the reflective target imaged in step a) by using at least one processing device.

4. The method according to claim 3, wherein the image of the reflective target imaged in step a) is transferred into a structural element prior to conducting step c).

5. The method according to claim 4, wherein in step c) at least one of a path of the laser irradiation, a movement path of the reflective target, a movement path of a holder of the reflective target, a laser power and a laser focus, is calculated based on the structural element.

6. The method according to claim 3, wherein the image evaluation algorithm comprises identifying at least one pattern indicative of the sample in the image.

7. The method according to claim 6, wherein the reflective target comprises at least one pre-defined reference structural element, wherein the image evaluation algorithm comprises considering information on the pre-defined reference structural element for localizing the sample region in the image.

8. The method according to claim 7, wherein the image evaluation algorithm comprises at least one pattern recognition algorithm using the information on the pre-defined reference structural element for identifying the pattern indicative of the sample in the image.

9. The method according to claim 7, wherein the information on the pre-defined reference structural element is used for defining a region of interest in the image.

10. The method according to claim 1, wherein the computer-implemented method for detecting at least one analyte in a sample with a laser desorption mass spectrometer is conducted at least partially automatically.

11. The method according to claim 1, wherein the computer-implemented method for detecting at least one analyte in a sample with a laser desorption mass spectrometer is conducted fully automatically.

12. The method according to claim 1, wherein the reflective target has a specular reflection of ≥45%.

13. The method according to claim 1, wherein the reflective target has a nominal arithmetic roughness of Rₐ≤2 μm.

14. A system comprising at least one laser desorption mass spectrometer, wherein the system is configured for performing a computer-implemented method for detecting at least one analyte in a sample according claim 1, wherein the laser desorption mass spectrometer comprises at least one reflective target, wherein at least one sample is applicable on the reflective target, wherein the sample comprises at least one analyte,
wherein the laser desorption mass spectrometer is configured for detecting the at least one analyte in the sample using surface assisted laser desorption ionization mass spectrometry (SALDI-MS), wherein the laser desorption mass spectrometer comprises at least one laser source, wherein the laser source is configured for applying laser irradiation to the reflective target such that at least one ion of the at least one analyte is generated, wherein the laser desorption mass spectrometer comprises at least one of a mass analyzing unit or an ion-mobility spectrometry device configured for detecting said ion,
wherein the system comprises at least one imaging device configured for imaging the reflective target,
wherein the laser desorption mass spectrometer comprises at least one control device configured for steering the laser irradiation on the localized sample region.

15. (canceled)
